(19) United States
(12) Patent Application Publication
(10) Pub. No.: US 2015/0038347 A1
(43) Pub. Date: Feb. 5, 2015

(54) SURFACE ENHANCED RAMAN SPECTROSCOPY

(71) Applicants: Patrick A. Johnson, Laramie, WY (US); Hao Zhang, Laramie, WY (US); Mark Harpster, Laramie, WY (US)

(72) Inventors: Patrick A. Johnson, Laramie, WY (US); Hao Zhang, Laramie, WY (US); Mark Harpster, Laramie, WY (US)

(73) Assignee: The University of Wyoming,an institution of higher of the State of Wyoming, Laramie, WY (US)

(21) Appl. No.: 13/635,973

(22) PCT Filed: Mar. 21, 2011
(86) PCT No.: PCT/US11/29286

§ 371 Date: Aug. 19, 2014

Related U.S. Application Data
(60) Provisional application No. 61/449,042, filed on Mar. 3, 2011.
(60) Provisional application No. 61/315,887, filed on Mar. 19, 2010.

(51) Int. Cl. G01N 21/65; G01J 3/44

(52) U.S. Cl. CPC G01N 21/658; G01J 3/4412; G01N 2201/061
USPC 506/9

(57) ABSTRACT

Rapid surface enhanced Raman spectroscopy (SERS) assays for ultratrace pathogen detection are provided. One-particle and two-particle sensor assays (e.g., biosensor assays) are provided. In one implementation, for example, an assay forms and concentrates a DNA hybridization complex incorporating paramagnetic particles and Raman active noble metal (e.g., gold, silver and/or copper) nanoparticles (two-particle sensor) or noble metal coated paramagnetic particles that provide both a SERS substrate and magnetic capture ability in a single sensor particle via a noble metal-coated paramagnetic particle, such as a gold-coated paramagnetic particle (one-particle sensor).

### CROSS-REFERENCE TO RELATED APPLICATIONS

This application is a national stage filing under 35 USC 371 of international application number PCT/US2011/029286, dated 21 Mar. 2011, and published on 22 Sep. 2011 under international publication number WO 2011/116402, which claims the benefit of U.S. provisional application No. 61/315,887, filed 19 Mar. 2010, and U.S. provisional application No. 61/449,042, filed 3 Mar. 2011, all three of which are hereby incorporated by reference as though fully set forth herein.

### BACKGROUND OF THE INVENTION

a. Field of the Invention

The instant invention relates to surface enhanced Raman spectroscopy magnetic capture-based assays.

b. Background Art

Since its first observation, surface-enhanced Raman scattering (SERS) has been developed as a powerful analytical tool that can provide detailed information about a molecule's structure. Upon laser excitation, molecules efficient in the inelastic scattering of light yield distinct Raman “signature” peak profiles that reflect the molecule's elevation from its initial ground state and subsequent return to a different vibrational state. Although detection sensitivity is generally low for gaseous compounds and molecules in solution, it was found that the positioning of molecules at, or near, noble metal surfaces, particularly Au and Ag (and sometimes copper), dramatically amplified the intensity of Raman signaling by an order of 10⁶-10⁸. This effect is attributed to the localization of chemi- and physi-adsorbed Raman scattering molecules within the enhanced electromagnetic (EEM) field which arises from the laser excitation of noble metal surface (i.e. SERS substrate) electron oscillations. Several studies investigating the mechanism of SERS enhancement have reported that the highest levels of enhancement are recorded for Raman scattering compounds sequestered within EM “hot spots” which are defined as the interstitial spaces of nanoparticle (NP) aggregates and the fractal spaces of nanofabricated solid surface SERS substrates. Analytical measurements predict that the SERS sensing range for a Raman-active compound in relation to the surface of a SERS-active metal substrate decreases ten-fold for each distance of 2.3 nm.

Based on these principles, significant research effort has focused on the development of SERS biosensor assays for the biomedical detection of proteins and nucleic acids. Experimental designs and end-user applications can vary widely, but many published reports to date have described proof-of-concept assays predicated on the use of nanoparticle or solid surface SERS-active substrates fabricated with capture molecules (e.g. antibodies in the case of antigen detection and complementary oligonucleotides for targeted nucleic acid sequence capture) and a suitable Raman reporter molecule. Because many biological molecules targeted for capture and detection are inherently weak Raman scatterers, strong Raman scatterers, many of which are heterocyclic dye compounds, are selected as reporters for providing robust SERS signaling and low limit of detection (LOD) sensitivities for the analyte in question.

Despite a lag in the commercialization of SERS-based diagnostic products and assays, SERS nevertheless affords a number of advantages over currently used assays based on enzyme-linked immunosorbent assays (ELISA) and qRT-PCR technologies. These include: 1) SERS reporters demonstrate a reduced susceptibility to photobleaching; a property of the fluorophores commonly used in ELISA and qRT-PCR which limits detection sensitivity at higher energy excitations, 2) SERS reporters are spectroscopically “bright” due their large enhancements, which confers high detection sensitivity and rapid assay times, and 3) SERS spectra contain a high information content that is attributed to narrow spectral band widths. The latter attribute provides for a significant increase in the number of mutiplexed spectra that can be resolved in an assay. Fourier transform (FT) of a representative Raman spectrum converts the number of non-zero elements into several discrete frequencies, or information elements. In contrast, FT of the broad spectrum emission characteristic of a fluorescent reporter molecule is denoted by a single information element that may not be clearly distinguished from other fluorescing compounds in an assay.

Currently, many SERS-based immunoassays in the developmental stage have been designed according to sandwich assay formats in which target antigens or antibodies are first immobilized by immuno-recognition molecules conjugated to solid surface SERS-active substrates and then incubated with Raman reporter-conjugated nanoparticles that are similarly fabricated for analyte capture. In an early example of this assay, Grubisha, D. S., Lipert, R. J., Park, H.-Y., Driskell, J., Porter, M. D., 2003, Femtomolar detection of prostrate-specific antigen: an immunoassay based on surface-enhanced Raman scattering and immunogold labels, Anal. Chem., 75, 5936-5943 reported the detection of 1 pg/ml prostate specific antigen (PSA) in human serum using Au-plated glass slides containing bound anti-PSA monoclonal antibodies (Mab) and Au nanoparticles (GNPs) conjugated with the Raman reporter 5,5′-dithiobis(succinimide-2-nitrobenzoate) (DSNB) and a different anti-PSA Mab. PSA-mediated tethering of gold nanoparticles to the solid phase Au substrate positioned DSNB within the EEM field of the sandwiched Au bi-layer for SERS signaling upon laser excitation. Examples of variant assays based on this detection format have demonstrated low LOD sensitivities for intact feline calicavirus virions in cell culture medium, cell surface antigen and intact bacterium of Mycobacterium avium and human IgG. Provided with the appropriate engineered modifications of Raman microscopic instrumentation, solid substrate-based sandwich assays can be adapted to a multiplex-capable microarray chip format suited for high-throughput analysis in a modern clinical facility.

As an alternative to solid substrate-based assays, several immunoassays have been developed that are conducted in solution using nanoparticles fabricated with target analyte recognition molecules and a Raman reporter molecule. Analyte detection is facilitated by the SERS signaling of Raman reporters confined within the “hot spots” of aggregated nanoparticle immunocomplexes that either develop as a consequence of antigen-antibody interactions, or are experimentally induced by chemical procedures (i.e. the addition of halide ions). Nanoparticle-based assays possess the advantages of reduced assay times from the point of reagent assembly to spectrum data acquisition and the capability of performing assays using compact and relatively inexpensive Raman spectroscopic instrumentation. The short incubation times are largely attributed to the reduced dependency of nanoparticle surface-ligand binding interactions in solution on the mass transport effects of biological macromolecules with small diffusion coefficients. To improve detection sensitivity and establish experimental conditions whereby aggregation can be reliably reproduced, Gong, J.-L., Liang, Y., Huang, Y., Chen, J.-W., Jiang, J.-H., Shen, G.-L., Yu, R.-Q., 2007, Ag/SiO₂ core-shell nanoparticle-based surface-enhanced Raman probes for immunoassay of cancer marker using silica-coated magnetic nanoparticles as separation tools, Biosens. Bioelectron., 22, 1501-1507 developed a 2-particle SERS immunoassay consisting of Raman reporter molecule-embedded, Ag/SiO₂ core-shell NPs (SNPs) coated with polyclonal antibodies (Pab) specific for human α-fetoprotein (AFP) and paramagnetic NPs (PMPs) coated with anti-AFP Mabs. The AFP-mediated linkage of SNPs and GNPs yielded a detection limit of ˜10 pg/ml AFP in human serum for PMP-captured immunocomplexes that were retrieved from solution by magnetic pull-down and concentrated within the focal point of the interrogating laser. In a similar study using hollow Au nanospheres as the SERS substrate, Chon et al. have reported a LOD in human serum for the detection of the lung cancer marker, carcinoembryonic antigen, which is 100-1000× more sensitive than the LOD provided by the ELISA (see Chon, H., Lee, S., Son, S. W., Oh, C. H., Choo, J., 2009, Highly sensitive immunoassay of lung cancer marker carcinoembryonic antigen using surface-enhanced Raman scattering of hollow gold nanospheres, Anal. Chem., 81, 3029-3034). Related studies using 2-particle antigen capture assays have also demonstrated the potential clinical applicability of this technology by reporting the direct, rapid and sensitive detection of tumor cells in unprocessed human whole blood. Regardless of the specifics of assay design, however, it is generally agreed that the application of an external magnet source enhances analyte detection sensitivity by concentrating a greater number of Raman reporters within the collective EEM fields of tightly appressed GNPs and the focal point of the interrogating laser.

### BRIEF SUMMARY

A highly adaptable SERS immunoassay platform based on paramagnetic particle (PMP) capture is proposed to enable the rapid, sensitive and selective detection of analytes (e.g., nucleic acids and antigens or antibodies, such as in human serum, plasma and blood samples).

In one implementation, multifunctional, core-shell nanoparticles for magnetic capture-based SERS assays are provided. These nanoparticles simultaneously function as SERS substrates while providing a separation and concentration mechanism. The nanoparticles may enable highly sensitive and selective detection of analytes (e.g., nucleic acids or antibodies and antigens, such as in whole blood, plasma and serum). The reading of optimized assays using Raman spectrometer instrumentation capabilities may facilitate rapid assay times and data acquisition in a point-of-care (POC), or field setting.

In one implementation, for example, the assays include a one-particle analyte detection scheme (e.g., nucleic acid or antigen/antibody detection) using Au-coated (or other noble metal coated) paramagnetic particles and a Raman reporter-conjugated analyte recognition molecule (e.g., a nucleic acid or antibody/antigen recognition molecule).

In another implementation, an improved two-particle analyte capture and detection scheme is provided that provides low LODs for single antigens. Using the hepatitis A, B and C viruses (HAV, HBV and HCV) as model targets, monoplex and mutiplex immunoassays as example assays are provided.

In one implementation, for example, a detection assay for detecting a target nucleic acid via surface enhanced Raman spectroscopy is provided. In this implementation, the assay comprises: a plurality of first particle biosensors comprising paramagnetic material coupled to a first nucleic acid probe; and a plurality of second particle biosensors comprising a noble metal material coupled to a second nucleic acid probe and a Raman label, the first and second nucleic acid probes being complementary nucleic acid probes specific to the target nucleic acid.

In another implementation, a method of detecting a target nucleic acid via a magnetic capture-based surface enhanced Raman spectroscopy assay is provided. In this implementation, the method comprises: providing a plurality of first particle biosensors comprising paramagnetic material coupled to a first nucleic acid probe and a plurality of second particle biosensors comprising a noble metal material coupled to a second nucleic acid probe and a Raman label, the first and second nucleic acid probes being complementary nucleic acid probes specific to the target nucleic acid; mixing an analyte comprising the target nucleic acid with the plurality of first particle biosensors and second particle biosensors, wherein the first and second nucleic acid probes bind to the target nucleic acid; exposing the mixture of the analyte and particle biosensors to an electromagnetic field to attract the first particle biosensors to a target location; exciting the target location with an excitation light source; and detecting a Raman signal corresponding to the Raman label indicating the presence of the target nucleic acid.

In yet another implementation, a method of detecting a target nucleic acid via a magnetic capture-based surface enhanced Raman spectroscopy assay is provided. In this implementation, the method comprises: providing a plurality of first particle biosensors comprising paramagnetic material coupled to a first nucleic acid probe and a plurality of second particle biosensors comprising a noble metal material coupled to a second nucleic acid probe and a Raman label, the first and second nucleic acid probes being complementary nucleic acid probes specific to the target nucleic acid; mixing an analyte with the plurality of first particle biosensors and second particle biosensors, wherein the first and second nucleic acid probes bind to the target nucleic acid if the target nucleic acid is present in the analyte; exposing the mixture of the analyte and particle biosensors to an electromagnetic field to attract the first particle biosensors to a target location; exciting the target location with an excitation light source; and determining whether a Raman signal corresponding to the Raman label indicating the presence of the target nucleic acid is received.

In another implementation, a detection assay for detecting a target nucleic acid via surface enhanced Raman spectroscopy magnetic capture-based assay is provided. In this implementation, the assay comprises: a plurality of particles comprising an inner paramagnetic particle at least substantially coated by a noble metal coating, the particle further comprising a target-specific probe for selectively coupling to the target analyte; and a plurality of Raman label conjugated target analyte recognition elements.

In yet another implementation, a method of detecting a target analyte via a magnetic capture-based surface enhanced Raman spectroscopy assay is provided. In this implementation, the method comprises: providing a plurality of particles comprising an inner paramagnetic particle at least substantially coated by a noble metal coating, the particle further comprising a target-specific probe for selectively coupling to the target analyte; and a plurality of Raman label conjugated target analyte recognition elements; mixing an analyte comprising the target analyte with the plurality of particles and Raman label conjugated target analyte recognition elements, wherein the target-specific probe and Raman label conjugated target analyte recognition elements bind to the target analyte; exposing the mixture of the analyte, particles and Raman label conjugated target analyte recognition elements to an electromagnetic field to attract the plurality of particles to a target location; exciting the target location with an excitation light source; and detecting a Raman signal corresponding to the Raman label indicating the presence of the target analyte.

In another implementation, an assay for detecting a target analyte via surface enhanced Raman spectroscopy is provided. In this implementation, the assay comprises: a plurality of first nanoparticle biosensors comprising paramagnetic material coupled to a first probe; and a plurality of second nanoparticle biosensors comprising a noble metal material coupled to a second probe and a Raman label, the first and second probes being adapted to selectively couple to the target analyte.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an example chemical structure of a Raman label used immobilize DNA to a gold nanoparticle.

FIG. 2 shows TEM images of example 6 nm silica-coated magnetic nanoparticles.

FIG. 3 shows an example schematic diagram of gold and iron nanoparticle probes with DNA sequences complementary to different parts of target DNA.

FIG. 4 shows an example illustration of a hybridization complex of the gold and iron nanoparticles shown in FIG. 3 after complexation by the target DNA and its Raman measurement when dispersed in buffer solution.

FIG. 5 shows an example illustration of a Raman test for a magnetically concentrated Raman active gold/iron nanoparticle complex such as shown in FIGS. 3 and 4.

FIG. 6 shows aggregation behavior of the mixed gold and iron nanoparticle probes shown in FIGS. 3-5 under optimal hybridization conditions, with (right) and without (left) target DNA sequence, before (upper) and after (bottom) concentration by the magnet.

FIG. 7 shows a focused laser beam on a gold/iron nanoparticle combination complex magnetically collected at the corner of the vial.

FIG. 8 shows an example Raman spectrum of a Raman label in (1) a gold/iron nanoparticle combination complex shown in the top waveform, in (2) a gold/iron nanoparticle combination complex dispersed in buffer solution shown in the bottom waveform, and (3) the dense mass of the dry Raman active gold nanoparticles shown in the middle waveform.

FIG. 9 shows an example SERS detection of a model paramagnetic nanoparticle (MNP)-captured hybridization complex containing a West Nile Virus (WNV) target DNA sequence.

FIG. 10 shows example chemical structures of reporter Au nanoparticles (GNPs) and capture MNPs at successive steps in an example fabrication process.

FIG. 11 shows an example chemical shift spectrum of a Raman label (NSNB).

FIG. 12 shows an example SERS spectra for DNA-functionalized Raman label.

FIG. 13 shows an example TEM image of amine-functionalized silica-coated MNPs.

FIG. 14 shows an example TEM image of DNA functionalized MNPs.

FIG. 15 shows example TEM images of DNA hybridization reactions conducted in the presence (upper panel) and absence (lower panel) of a WNV target sequence.

FIG. 16 shows an example XPS C (1s) spectra for silica-coated MNPs (bottom spectrum) and silica-coated MNPs fabricated with SM(PEG)₂ (top spectrum) and XPS N (1s) spectra for DSNB-conjugated GNPs (bottom spectrum) and DSNB-conjugated GNPs fabricated with reporter probe (top spectrum).

FIG. 17A shows example SERS spectra for WNV target sequence capture for (a) stacked spectra for magnetically pulled-down DNA hybridization containing reporter GNPs, captured MNPs and WNV target DNA (spectra a); (b) magnetically pulled-down reporter GNP, captured MNP and BTV target hybridization (spectra b); (c) magnetically pulled-down hybridization reaction containing only reporter GNPs and capture MNPs (spectra c); and (d) reporter GNPs, capture MNPs and WNV target DNA hybridization in solution (spectrum d).

FIG. 17B shows an example stacked spectra for DNA hybridizations containing dilutions of WNV target DNA: 100 nM (spectrum a), 10 nM (spectrum b), 1 nM (spectrum c), 100 pM (spectrum d), 10 pM (spectrum e).

FIG. 17C shows an example plot of SERS intensity at peak 1330 cm⁻¹ versus log₁₀ concentration target sequence DNA.

FIG. 18 shows and example XPS P (2p) spectra of fabricated reporter GNPs (top profile) and capture MNPs.

FIG. 19 shows example SERS spectra for example Raman labels Malachite Green (MG), Nile Blue (NB), and IR-792.

FIG. 21 shows example TEM images of Fe₃O₄ (A) 3 nm, (B) 7 nm and (C) 10 nm. Iteratively gold coated 10 nm Fe₃O₄ nanoparticles (D) 11 nm, (E) 15 nm and (F) 19 nm.

FIG. 22 shows example XRD spectrum for pure Au (upper spectrum 2200), pure Fe₃O₄ (spectrum 2202), Fe₃O₄ nanoparticles (spectrum 2204) and Au coated Fe₃O₄ nanoparticles (spectrum 2206).

FIG. 23 shows an example UV-Vis spectra for (a) pure Au particles, (b) Fe₂O₃ particles, (c) Au coated MNP in hexane and (d) Au coated MNP in water after rinsing.

FIG. 24 shows an example SERS spectra for Erythrosin (A) on pure Au nanoparticles (2400) and on Au coated MNP (2402), and malachite green (B) on pure Au nanoparticles (2404) and on Au coated MNP (2406).

### DETAILED DESCRIPTION

Rapid surface enhanced Raman spectroscopy (SERS) assays for ultratrace pathogen detection are provided. One-particle and two-particle sensor assays (e.g., biosensor assays) are provided. In one implementation, for example, an assay forms and concentrates a DNA hybridization complex incorporating paramagnetic particles and Raman active noble metal (e.g., gold, silver and/or copper) nanoparticles (two-particle sensor) or noble metal coated paramagnetic particles that provide both a SERS substrate and magnetic capture ability in a single sensor particle via a noble metal-coated paramagnetic particle, such as a gold-coated paramagnetic particle (one-particle sensor). Although many examples described herein refer to gold or Au materials, other noble metals, such as silver (Ag) or copper (Cu) are also contemplated and may be used in each of the examples.

To limit the effects of outbreaks of emerging diseases, such as H1N1, Influenza A, and SARS, new diagnostics technology are provided that can rapidly identify pandemic diseases. In one implementation, a method to enable reliable rapid diagnostics that can detect and identify pathogens is provided. Current methods to diagnose emerging infectious diseases are either time consuming, not user friendly, or lack sufficient sensitivity. In one implementation, a rapid, reliable, high sensitive bisosensing platform for emerging infectious diseases is provided. In addition, a portably designed system for field use with low testing costs is also provided.

In one implementation, multifunctional, core-shell nanoparticles for magnetic capture-based SERS assays are provided. These nanoparticles simultaneously function as SERS substrates while providing a separation and concentration mechanism. The nanoparticles may enable highly sensitive and selective detection of antibodies and antigens, such as in whole blood, plasma and serum.

In one particular implementation, an integrated SERS immunoassay platform may provide one or more of the following analytical figures of merit of robust biosensors. Rapid assay times (e.g., under 10 minutes) may be provided from the point of mixing biological specimens with nanoparticles assay reagents to performing Raman spectral acquisitions. Antigen/antibody sensitivity may be provided greater than ELISA. Selective detection due to magnetic concentration of the target antigen/antibody analyte and use of spectrally distinct Raman reporter compounds may also be provided. Although examples are provided with limited numbers of reporters (e.g., three) significantly higher levels of multiplexing are possible. Low-cost consumables and a Raman reader may be provided. In one implementation, for example, a proposed assay may provide minimally fabricated nanoparticles that are stable and can be developed as pre-packaged reagents for single-use assay applications. Assay portability and user-friendly operational procedures permits rapid diagnosis in settings other than state-of-art clinical research facilities. Assays may be highly adaptable. In one implementation, for example, assay designs used for an assay for the diagnosis of hepatic viral infections may be easily adapted for the detection of any disease pathogen as long as antigen/antibody reagents are available.

A SERS-based assay platform with sensitive and monoplex or multiplex detection capabilities for proteins, and nucleic acids as well, using portable instrumentation which will permit rapid detection in situations and locales that are normally restrictive to clinical diagnosis may be provided with particles for magnetic capture-based SERS assays. In one implementation, these particles, for example, may comprise nanoparticles that provide more rapid diffusion within an analyte for a one-particle or two-particle magnetic capture-based SERS assay. In another implementation, a one-particle magnetic capture-based SERS assay can be provided in which a single particle (e.g., nanoparticle or other sized particle) provides both a SERS substrate and magnetic capture ability via a gold-coated paramagnetic particle. A gold or silver coating of a paramagnetic particle, for example, provides a relatively large surface area for the SERS substrate effect of the particle.

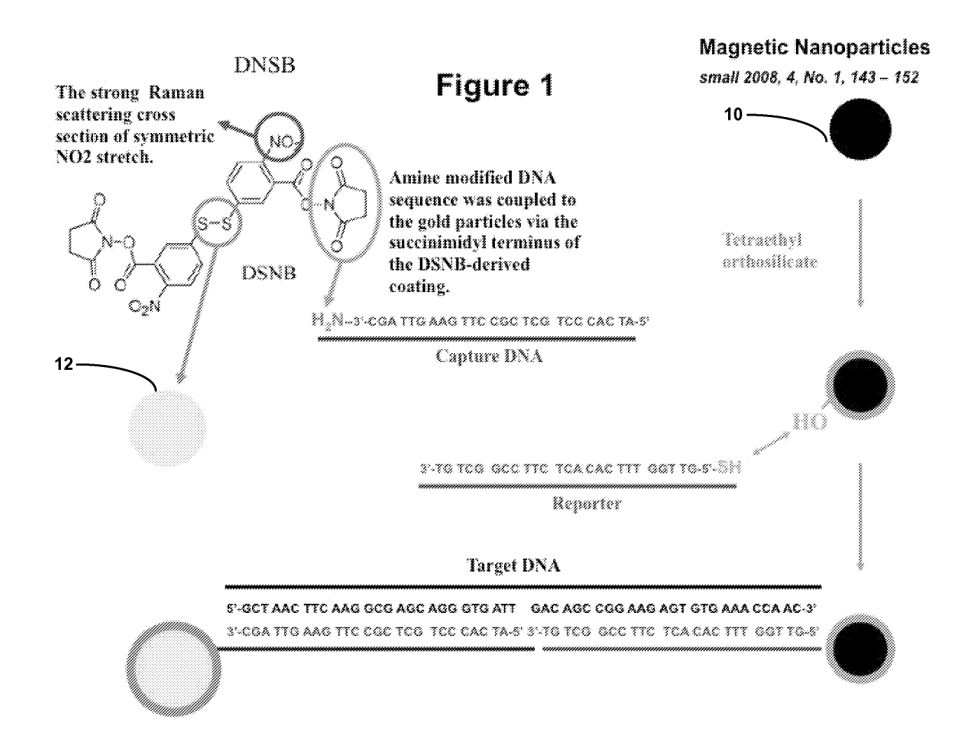

FIG. 1 shows an example method using a two-particle biosensor in which a surface enhanced Raman spectroscopic (SERS) based assay for West Nile Virus nucleic acids, has been developed as a prototype for other emerging infectious diseases nucleic acid detection. A target DNA sequence derived from the West Nile Virus (WNV) genome is captured by two complementary DNA probes which are immobilized on paramagnetic nanoparticles 10 and Raman active gold nanoparticles 12 respectively, to form a complex able to generate a further enhanced Raman signal after concentration by magnetism.

In FIG. 1, an example chemical structure of a Raman label (DNSB) used immobilize DNA to a gold nanoparticles is shown. In addition, a modified method to immobilize the captured DNA on magnetic nanoparticles is shown. The Raman active gold nanoparticle probes hybridize to a different portion of the target DNA sequence than the capture probe on the magnetic nanoparticles. (Bottom)

Raman active gold nanoparticles may be prepared in any number of methods. In one implementation, for example, citrate stabilized gold nanoparticles of various sizes can be purchased (such as from Ted Pella, Inc.) or synthesized by well-known protocols. In one particular implementation, an optimum size of the gold nanoparticles is wavelength specific and is chosen according to the Raman spectrometer laser being used. The particles are then modified with Raman active molecules by physisorption or with thiol containing molecules. In this implementation, the degree of modification is controlled by carefully titrating the dye concentration to achieve partial coverage. Further modification with the capture probes, such as thiol modified single stranded DNA oligonucleotides, is easily achieved by incubating the partially modified gold nanoparticles with the corresponding capture probe. Multiplexed assays can be developed by pairing specific capture agents with specific Raman dyes.

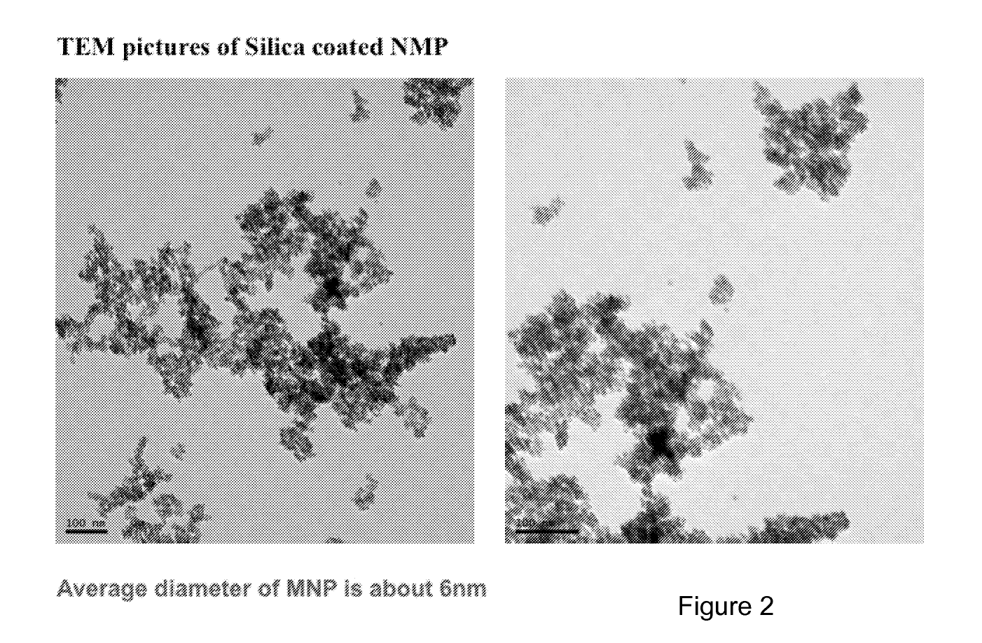

In this example, paramagnetic nanoparticles can be purchased or synthesized, such as by the protocol developed by Lee and coworkers (Lee et al, Small 2008, 4, No. 1, 143-152). This method consists of a simple one-pot synthesis of uniformly sized silica-shell superparamagnetic nanoparticles by the simple addition of tetraethyl orthosilicate (TEOS) in reverse micelles during the formation of uniformly sized magnetite nanoparticles. The superparamagnetic nanoparticles are functionalized by APTES to achieve an amine condensed surface which can then be linked to a thiol or amine modified DNA oligonucleotide via common cross-linking molecules, such as SM(PEG)ₙ (Invitrogen, Inc.). FIG. 2 shows TEM images of example 6 nm silica-coated magnetic nanoparticles.

In an alternative implementation, gold coated superparamagnetic nanoparticles may be created as a capture particle. In this implementation, a functionalization of the surfaces with gold nanoshells on silica-shell superparamagnetic nanoparticles is performed in a two-step reaction. In one particular implementation, for example, 1-2 nm gold nanoparticles were first attached on APTES modified silica coated superparamagnetic nanoparticles and second, a gold nanoshell was grown, such as by reducing a hydrogen tetrachloroaurate (III) hydrate (1% HAuCl4) (Langmuir 2002, 18, 4915-4920). Subsequently, modification with capture probes, such as thiol modified single stranded DNA oligonucleotides, can be achieved by incubating the gold coated superparamagnetic nanoparticles with the corresponding capture probe.

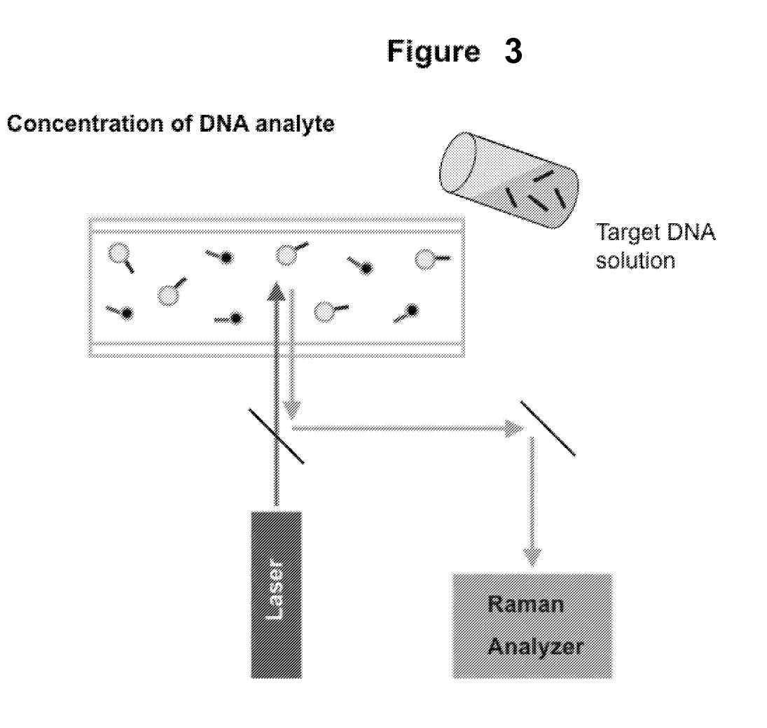

FIG. 3 shows an example schematic diagram of gold nanoparticles probes and iron nanoparticle probes with DNA sequences complementary to different parts of target DNA. As shown in FIG. 3, a DNA analyte containing a target DNA solution is added to the probes, and the target DNA (if present) interacts with the gold nanoparticles probes and iron nanoparticle probes with DNA sequences complementary to different parts of target DNA.

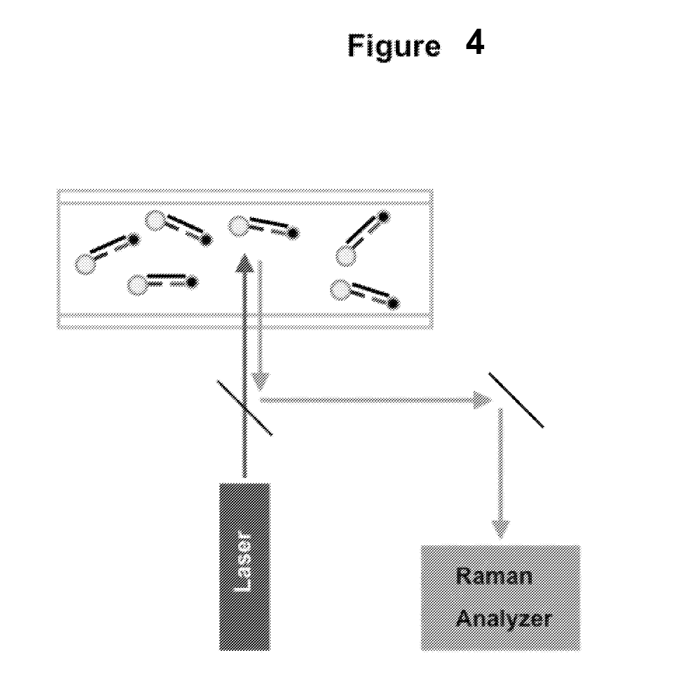

FIG. 4 shows an example illustration of a hybridization complex of the gold and iron nanoparticles shown in FIG. 3 after complexation by the target DNA and its Raman measurement when dispersed in buffer solution.

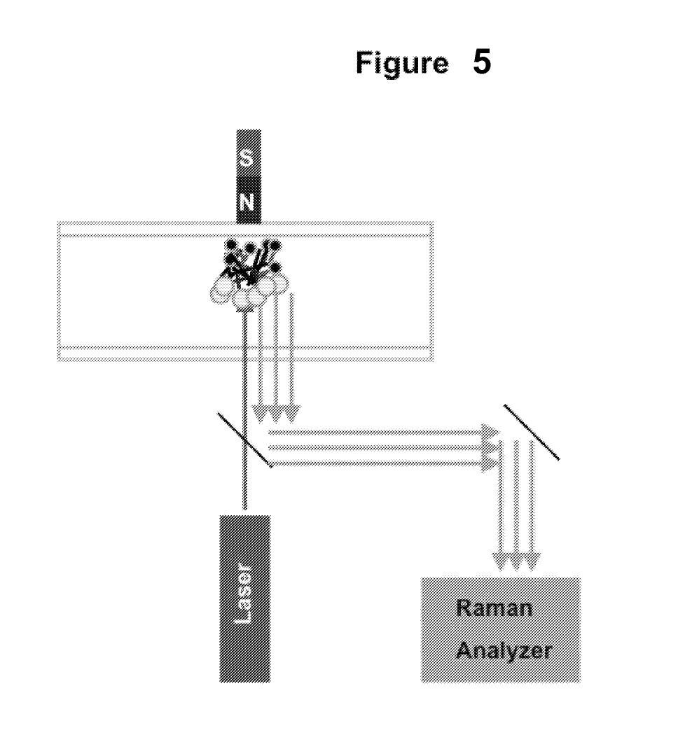

The combined particles can then be separated via an electromagnetic field, such as by placing a magnet adjacent to the complex. FIG. 5 shows an example illustration of a Raman test for a magnetically concentrated Raman active gold/iron nanoparticle complex.

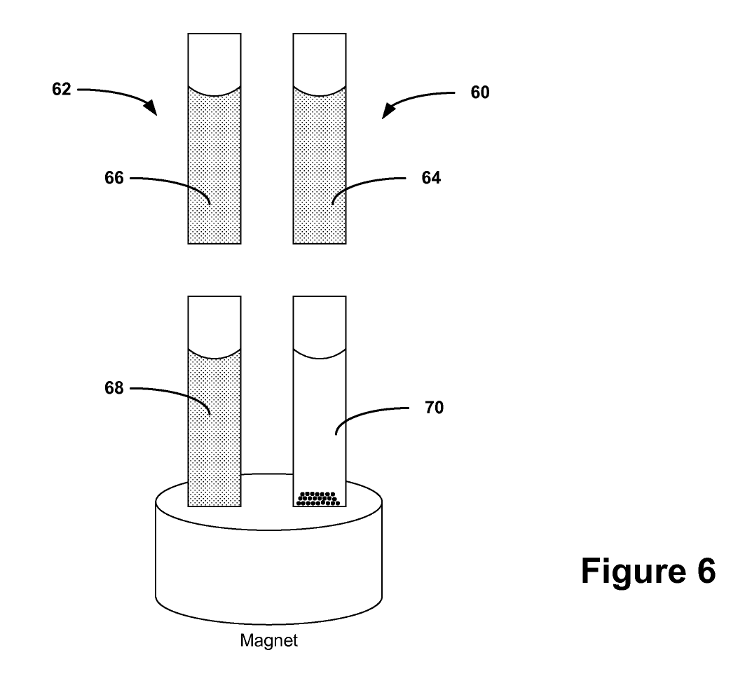

FIG. 6 shows aggregation behavior of the mixed gold and iron nanoparticle probes under optimal hybridization conditions, with a target DNA sequence present (right 60) and without the target DNA sequence (left 62), before (upper 64, 66) and after (bottom 68, 70) concentration by a magnet.

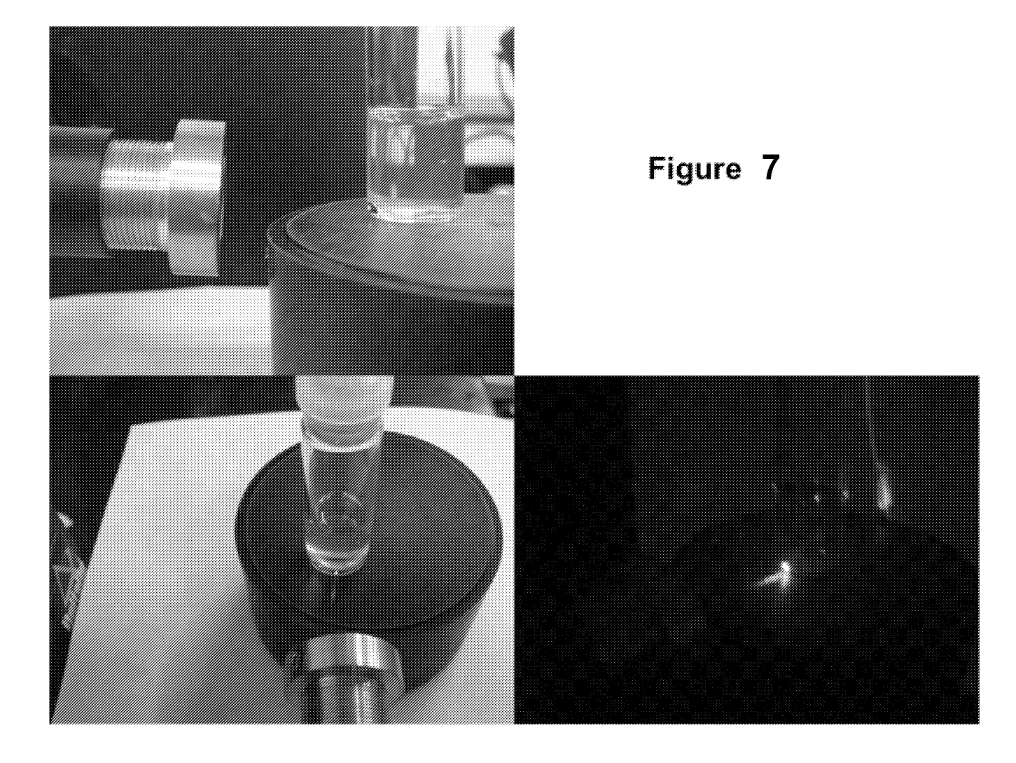

FIG. 7 shows a focused laser beam on a gold/iron nanoparticle combination complex magnetically collected at the corner of the vial.

In an alternative to using uncoated or silica coated superparamagnetic nanoparticles as shown in the example of FIGS. 1-7, gold coated superparamagnetic nanoparticles can be used as a capture particle in a one-particle biosensor implementation. The addition of the gold layer has the added benefit of increasing the nanostructured gold content and provides further SERS enhancement due to the increased probability of the Raman molecule being within a “hot spot”. In this particular implementation, the functionalization of the surfaces with gold nanoshells on silica-shell superparamagnetic nanoparticles is a two-step reaction. In one particular implementation, for example, 1-2 nm gold nanoparticles were first attached on APTES modified silica coated superparamagnetic nanoparticles and second, a gold nanoshell was grown, such as by reducing a hydrogen tetrachloroaurate (III) hydrate (1% HAuCl4) (Langmuir 2002, 18, 4915-4920). Subsequently, modification with capture probes, such as thiol modified single stranded DNA oligonucleotides, can be achieved by incubating the gold coated superparamagnetic nanoparticles with the corresponding capture probe.

Example Ultratrace Raman Test

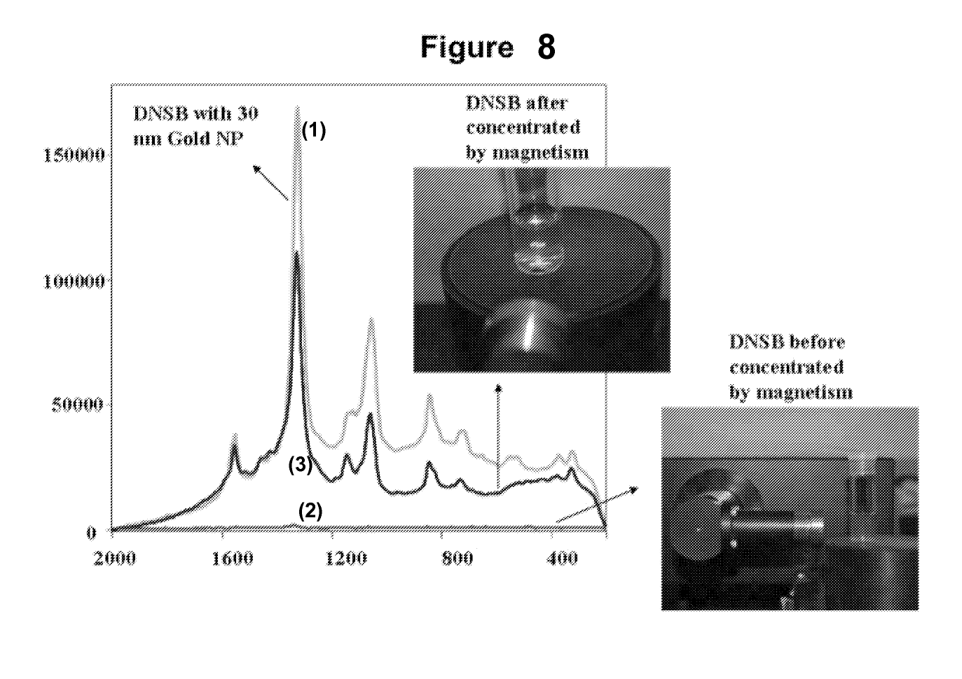

In one implementation, after the two kinds of functional particles are made, the particles are mixed with a target DNA sequence under optimal hybridization conditions (e.g., for 1 hour) to form a hybridization complex. In our initial experiments, the color of the solution became darker, compared to the particle mixture without target DNA sequence. The solution then became almost transparent after precipitation by magnetism, while the solution without target DNA sequence turned pink, which is the color of gold nanoparticle solutions. This result indicates the success of forming the complex after adding target DNA sequence into the particle solution. We were able to collect the complex at a small corner of the sample vial and focus the laser beam on it. A very strong SERS signal is shown in FIG. 8 (middle trace (2)), compared to the solution before magnetic concentration (FIG. 8 bottom trace (3)). The signal increased approximately 70 times. The enhanced spectra matches the characteristic spectrum of the dye modified gold nanoparticles interrogated in a dry condition as a positive control.

Two-Particle Assay

In one implementation, a two-particle sensor assay for Raman enhancement is provided. In one particular implementation, for example, an enhanced signal is from a magnetically concentrated combination product, which comprises an DNA analyte, a paramagnetic particle modified with a probe oligonucleotide, and a spectral enhancement particle also modified with a probe oligonucleotide. In this implementation, the enhancement is about 100 times higher than by standard SERS experiments, with the potential to be further improved by optimization.

A model paramagnetic nanoparticle (MNP) assay is demonstrated for surface enhanced Raman scattering (SERS) detection of DNA oligonucleotides derived from the West Nile Virus (WNV) genome. In this example, detection is based on the capture of WNV target sequences by hybridization with complementary oligonucleotide probes covalently linked to fabricated MNPs and Raman reporter tag-conjugated Au NPs (GNPs), and the subsequent removal of GNP-WNV target sequence-MNP hybridization complexes from solution by an externally applied magnetic source. Laser excitation of the pelleted material provided a signature SERS spectrum which is diagnostic for the reporter, 5,5′-Dithiobis(succinimidy-2-nitrobenzoate) (DSNB), and restricted to hybridization reactions containing WNV target sequences. Hybridizations containing dilutions of the target oligonucleotide were characterized by a reduction in the intensification of the spectral peaks accorded to the SERS signaling of DSNB and the limit of detection for target sequence in buffer was 10 pM. Due to the short hybridization times required to conduct the assay and ease with which reproducible Raman spectra can be acquired, the assay is amenable to adaptation within a portable, user-friendly Raman detection platform for nucleic acids.

In this implementation, a paramagnetic NP (MNP) capture SERS assay is provided in which target DNA detection is enhanced in a manner analogous to aggregation by the magnetic pull-down and concentration of hybridization complexes. Au NPs (GNPs) stably conjugated with reporter oligonucleotide probes via a Raman reporter linker are first hybridized with a West Nile Virus (WNV) target DNA sequence and MNPs conjugated with capture oligonucleotide probes. Upon the application of an external magnet source, GNP-WNV target sequence-MNP hybridization complexes are removed from solution and a compacted pellet is interrogated with a laser. In this example, an LOD for WNV target sequence capture is 10 pM, a six-fold order of magnitude increase over the sensitivity previously reported for the detection of HIV DNA by Raman microscopy incorporating a magnetic separation step. See Liang, Y.; Gong, J. L.; Huang, Y.; Zheng, Y.; Jiang, J.-H., Shen, G.-L.; Yu, R.-Q., Talanta, 2007, 72, 443-449. In this particular implementation, the assay format provides a means for rapid analysis owing to the absence of mass transfer limitations during the solution phase hybridization reactions and to the immediate separation and localization of the magnetic pellet within the interrogating laser spot.

Experimental Data and Results

Reagents.

N-hydroxysuccinimide (NHS)-PEG₂-maleimide (SM(PEG)₂) was obtained from Thermo Fisher Scientific and colloidal GNPs from Ted Pella Inc. (30 nm, 2×10¹¹ NPs/ml). Unless indicated otherwise, all other chemicals and materials were purchased from Sigma-Aldrich. The DNA sequences of the WNV target oligonucleotide (REG2-TARGET53) and the blue tongue virus (BTV) control target oligonucleotide have been published elsewhere (see Harpster, M. H.; Zhang, H.; Sankara-Warrier, A. K.; Ray, B. H.; Ward, T. R.; Kollmar, J. P.; Canon, K. T.; Mecham, J. O.; Corcoran, R. C.; Wilson, W. C.; Johnson, P. A., Biosens. Bioelectron. 2009, 25, 674-681). The sequence and end terminal modification for the reporter probe, REG2-AS2-NH5, is 5′-/5AmMC6/-GTT GGT TTC ACA CTC TTC CGG CTG T-3′ and for the capture probe, REG2-AS1-SH3, is 5′-ATC ACC CTG CTC GCC TTG AAG TTA GC-/3ThioMC3-D/-3′. All of the oligonucleotides used in these experiments were HPLC purified and validated by quality control mass spectroscopy (IDT, Inc. Coralville, Iowa).

Preparation of GNPs Conjugated with Raman Label and Reporter Oligonucleotides.

The synthesis of the Raman reporter label 5,5′-Dithiobis(succinimidy-2-nitrobenzoate) (DSNB) and its subsequent attachment to 6 ml of colloidal GNPs was conducted according to Grubisha et al. (see Grubisha, D.; Lipert, R. J.; Park, H.-Y.; Driskell, J.; Porter, M. D., Anal. Chem. 2003, 75, 5936-5943). To attach the amino-terminal reporter probe, REG2-AS2-NH5, to the succinimidyl group of DSNB, DSNB-conjugated GNPs and 3.5 μM reporter probe in phosphate buffered saline (PBS; 10 mM NaPO4, 300 mM NaCl) pH 7.4 were incubated overnight at room temperature. Excess unconjugated reporter probe was subsequently removed by centrifugation (10000×g for 7 min.) and the GNP-DSNB-reporter probe pellet was washed and resuspended in 3 ml of PBS pH 7.4 for use in DNA hybridization reactions.

Preparation of Silica Shell-Coated MNPs Conjugated with Capture Oligonucleotides.

MNPs were prepared according to Lee et al. (see Lee, J.; Lee, Y.; Youn, J. K.; Na, H. B.; Yu, T.; Kim, H.; Lee, S.-M.; Koo, Y.-M.; Kwak, J. H.; Park, H. G.; Chang, H. N.; Hwang, M.; Park, J.-G.; Kim, J.; Hyeon, T., Small 2008, 1, 143-152). Briefly, 1.75 g of sodium dodecylbenzenesulfonate was sonicated in 15 ml of xylene and then mixed with 0.75 ml of 0.75 mM FeCl₂ and 1.5 mM Fe(NO₃)₃ in water. Following overnight incubation at room temperature, the reverse-micelle suspension was heated to 90° C. and 1 ml of hydrazine was added for the formation of MNPs. To coat the MNPs with amine-functionalized SiO₂, the MNPs were cooled to 40° C. and mixed with 2 ml of a 1:1 solution of tetraethyl orthosilicate (TEOS) and (3-aminopropyl) triethoxysilane (APTES). The final sample was washed with ethanol, precipitated by magnetic pull-down and then washed several times with PBS pH 8.0 and adjusted to a concentration of 0.73 mg/ml MNPs in PBS pH 8.0.

The N-hydroxysuccinimide- and maleimide-activated pegylated linker, SM(PEG)₂, was added to 5 ml of the silica-coated MNPs at a final concentration of 5 mg/ml. After an 8 h incubation at room temperature, amide-linked SM(PEG)₂-MNP conjugates were separated from solution by magnetic capture and washed several times with PBS pH 7.0 to remove unreacted linker. To generate MNP-SM(PEG)₂-oligonucleotide probe conjugates, thiol-modified REG2-AS 1-SH3 capture probe was added to MNP-linker conjugates at a final concentration of 3.5 μM and the mixture was then incubated overnight at room temperature. Following magnetic capture, the capture probe-conjugated MNPs were washed repeatedly and resuspended in 5 ml of PBS pH7.4 for use in target sequence detection experiments.

Characterization of Fabricated Capture MNPs and Reporter GNPs. Proton NMR analysis of synthesized DSNB was conducted using a Bruker model ARX-400 spectrometer (Billerica, Mass.). Transmission electron microscopy (TEM) imaging of NPs deposited on formaver-coated, mesh copper grid films (Electron Microscopy Sciences, Hatfield, Pa.) was performed using a Hitachi-H7000 TEM (Hitachi Hi-Tech, Tokyo). NP samples for TEM analysis were prepared by briefly dipping the grid films in very dilute solutions to prevent further aggregation during drying. NP size distributions were determined using a ZetaPALS spectrometer (Brookhaven Instruments, Holtsville, N.Y.). X-ray photoelectron spectroscopy (XPS) spectra of dried samples of MNP and GNP assemblies on glass slides were acquired at room temperature using the PE 5800 multitechnique surface analysis system (Physical Electronics, Eden Prairie, Minn.). The system is equipped with a hemispherical analyzer, a multichannel detector at 45° and monochromatic Al KR excitation radiation (1486.6 eV, 350 W). A pass energy of 23.35 eV was used, giving a half-width of the Au (4f7/2) peak of ˜0.8 eV. The Au 4f energies were adjust to 83.8 eV for purposes of reporting peak position. XPS traces were deconvoluted into separate peaks using the software program XPS Peak 4.1.

SERS Detection of WNV Target DNA by Magnetic Capture.

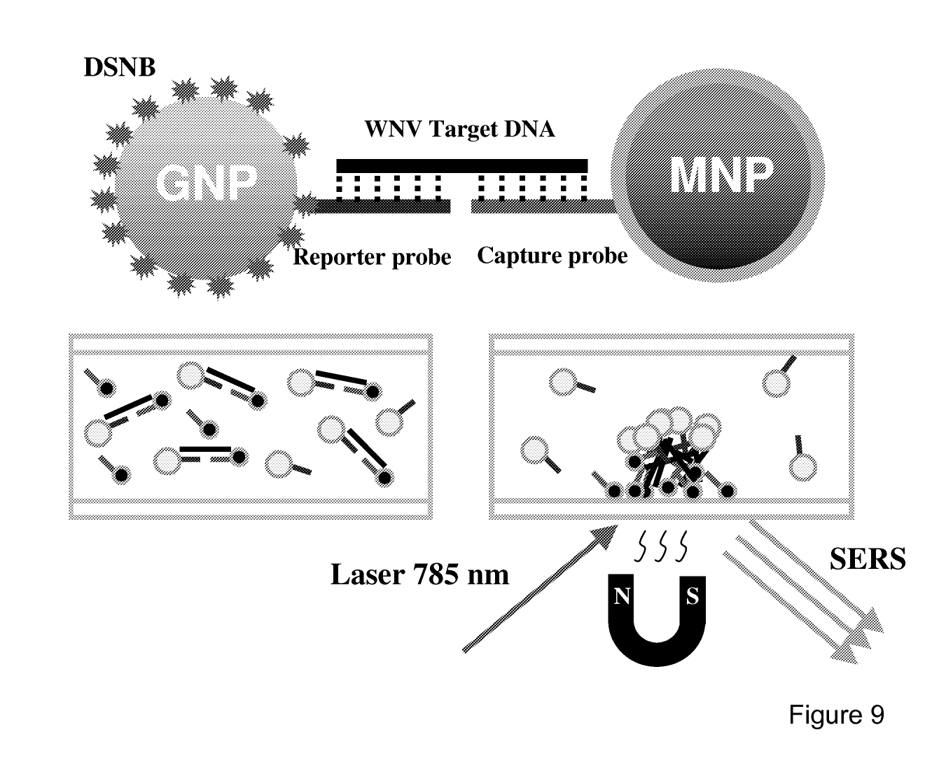

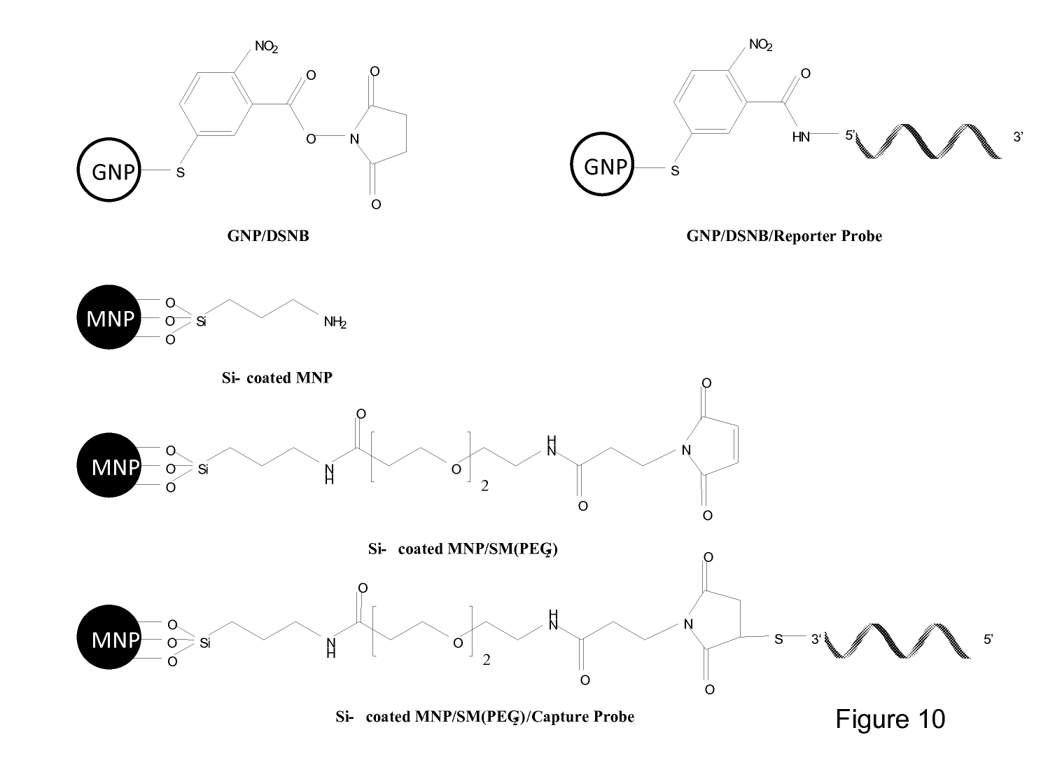

DNA hybridization reactions were conducted using 1 ml of reporter probe-conjugated GNPs, 0.5 ml of capture-probe conjugated MNPs and target and control DNA sequences in PBS pH 7.4. All hybridization reactions were conducted in capped glass vials for 1 h at room temperature, after which the hybridization complexes were precipitated from solution using a small external magnet. Laser excitation of concentrated sample pellets was performed using an Advantage NIR™ Raman spectrometer (DeltaNu Inc., Laramie, Wyo.) (60 mW power, 785 nm laser) fitted with right angle input optics. The scheme summarizing WNV DNA capture and detection is illustrated in FIG. 9 and the chemical structures of fabricated reporter GNPs and capture MNPs are shown in FIG. 10. Spectral data was acquired using NuSpec™ software and recorded in the 200-2000 vibrational unit range (Raman shift/cm⁻¹), with the baseline off, the resolution set a low and an integration time of 5 s. Grams/AI™ software (Thermo Fisher Scientific) was employed for data interpretation and manipulation.

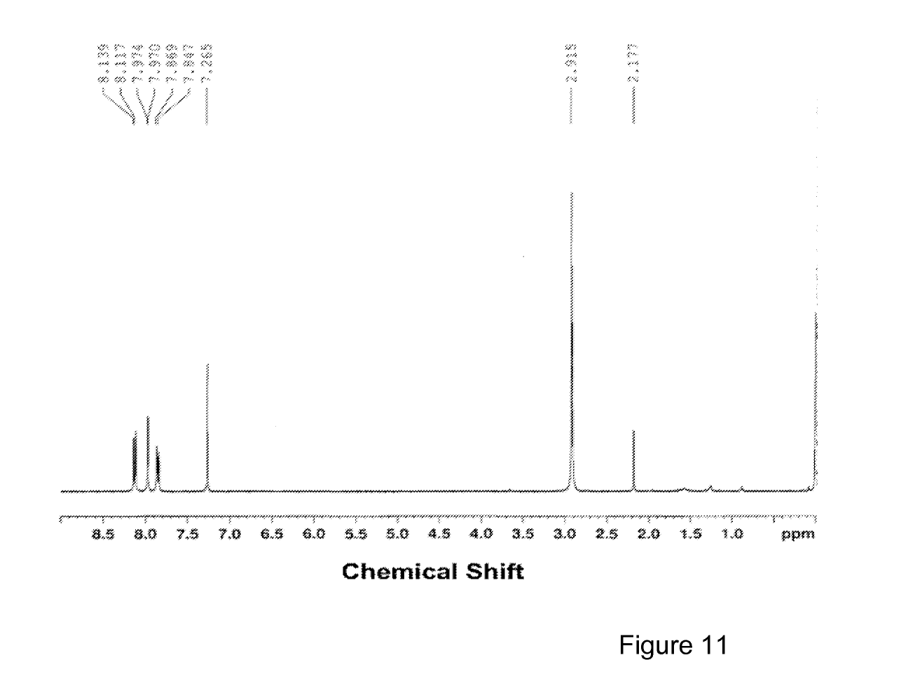

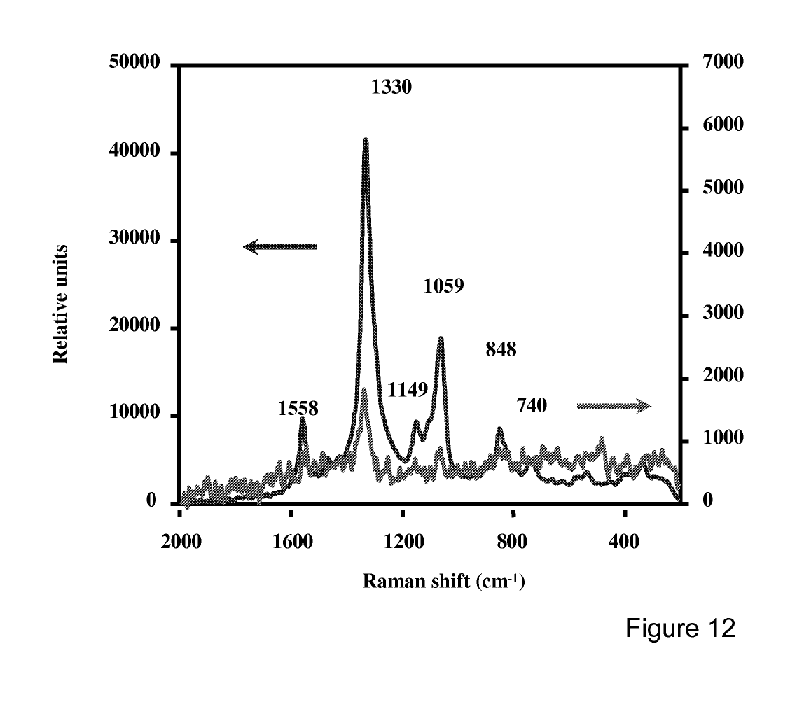

Fabrication of reporter GNPs and capture MNPs. The structure of the Raman label used in these studies, DSNB, was validated by ¹H NMR following its' synthesis and recrystallization from hexane/acetone according to Grubisha et al. (see Grubisha, D.; Lipert, R. J.; Park, H.-Y.; Driskell, J.; Porter, M. D., Anal. Chem. 2003, 75, 5936-5943). FIG. 11 shows an NMR chemical shift spectrum of DSNB: ¹H NMR (CDCl₃) δ=8.13 (d, 2H, ³J_{H,H}=8 Hz, C₆H₄), 7.847 (d, 2H, ³J_{H,H}=8 Hz, C₆H₄), 7.97 (s, 2H, C₆H₄), 2.915 (s, 8H, CH₂). The peak at 2.915 ppm and the multiplet at 7.847-8.139 ppm are diagnostic for DSNB, whereas the remaining peaks are provided by CDCl₃ solvent (7.265 ppm), acetone (2.177 ppm) and trace amounts of hexane (minor peaks at 1.622, 1.267 and 0.871 ppm). Thiolated DSNB conjugates of GNPs in aqueous solution and dried onto glass slides were analyzed by Raman spectroscopy. As the final step in the preparation of reporter GNPs, the amino-modified reporter oligonucleotide, REG1-AS2-NH5, was stably conjugated to DSNB-coated GNPs via amide linkage with the succinimide ester group of DSNB. FIG. 12 shows SERS spectra for DNA-functionalized DSNB-coated GNPs in 600 μl of water (red spectrum; 2×10¹¹ NPs/ml) and 20 μl of the same sample air-dried on a glass slide (blue spectrum). As shown in FIG. 12, laser excitation of dried DNA-functionalized DSNB-coated GNP samples provided discreet vibrational peaks at 1558, 1330, 1149, 1059, 848 and 740 cm⁻¹ that align with SERS spectra previously reported for DSNB. Aqueous samples, however, provided weakly intensified spectra in which the dominant 1330 and 1059 cm⁻¹ peaks were reduced by nearly twenty-fold in signal peak height. These results demonstrate GNP coverage with DSNB and the dependence of DSNB detection sensitivity on sequestration within the localized enhanced electromagnetic fields of concentrated NP SERS substrates (see Kovacs, G. J.; Loutfy, R. O.; Vincett, P. S., Langmuir 1986, 2, 689-694).

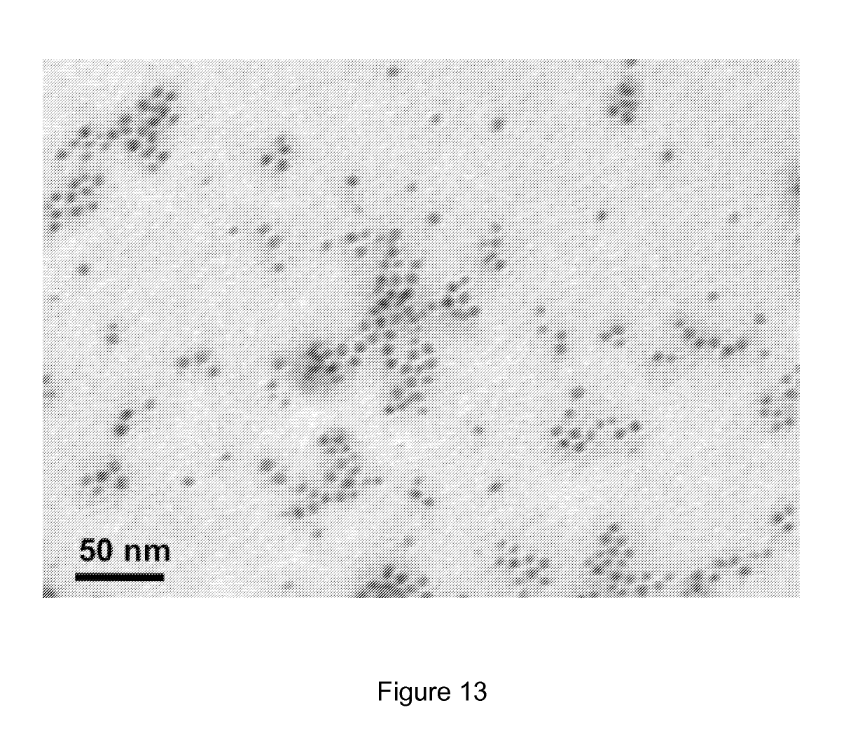

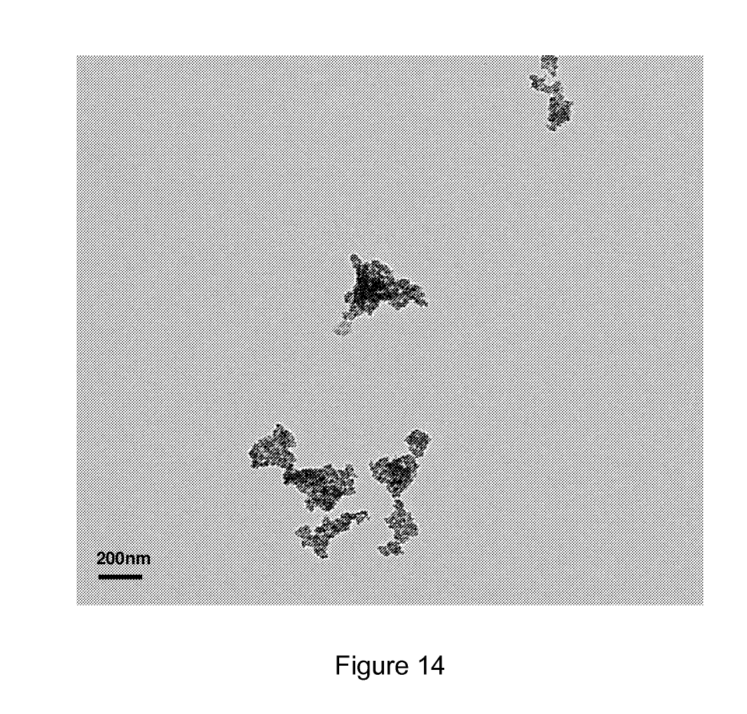

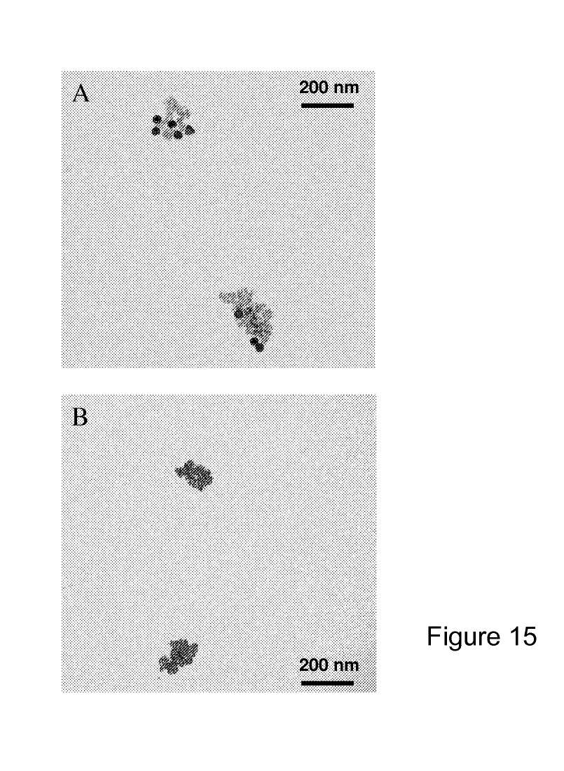

Silica coated MNPs functionalized with amine groups were imaged by TEM to determine the extent of particle dispersion versus aggregation FIG. 13 shows a TEM image of amine-functionalized silica-coated MNPs. In FIG. 13, the average size of individual MNPs is ˜6-7 nm of magnetic core material with a silica coating of ˜1-1.5 nm. The estimate for the thickness layer of silica coating for individual MNPs is inferred from the spatial distribution of high contrast magnetic core particles found in aggregate NP clusters. Although discreet nanoparticles of ˜6-7 nm in size were observed (see FIG. 13), the bulk of MNP preparations consisted of aggregated complexes of >200 nm in average size corroborated by DLS and TEM (see Table 2 and FIGS. 14 and 15). Aggregation is commonly observed for amine-functionalized silica-coated MNPs and, according to Bagwe, R.; Hilliard, L. R.; Tan, W., Langmuir, 2006, 22, 4357-4362, is attributed to non-specific inter-particle binding interactions arising from the hydrolytic polycondensation of TEOS and APTES and the absence of further silica surface modification with inert functional groups. To develop stable thioether bioconjugates of the thiol-modified capture oligonucleotide, REG1-AS1-SH3, with amine-functionalized MNPs, SM(PEG)₂ was used as a surface tethering linker.

XPS Characterization of Reporter GNPs and Capture MNPs.

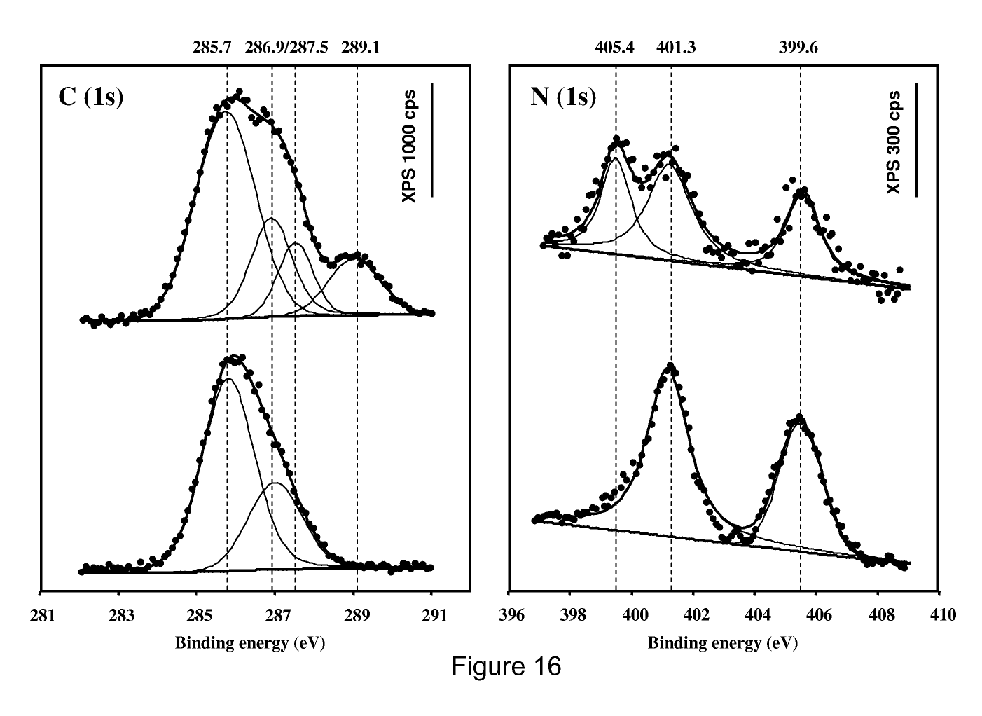

XPS analysis of NP assemblies was undertaken to determine element and chemical bond compositions and thereby confirm GNP and MNP surface modifications. In agreement with the structure of DSNB (FIG. 10), wide-scan XPS survey spectra for DSNB-conjugated GNPs provided binding energy peaks that indicate the presence of Au, S, C, O and N (Table 1). Peak values recorded for the Au (4f_{7/2}), C (1s), S (2p_{3/2}) and S (2p_{1/2}) electron orbital regions are in accordance with the binding energies measured for these regions in a study which reported on the assembly of functionalized benzophenone derivatives on Au films). The S (2p_{3/2}) and S (2p_{1/2}) doublet at 161.9 and 163.1 eV is consistent with the presence of Au-bound thiolates and the C (1s) 288.3, 286.3 and 284.7 eV peaks correspond to carbonyl Cs, the lower energy C—O, C—N and C—S bonds, and alkyl Cs, respectively. For the O (1s) region, the O of the aromatic nitro group is indicated by the peak at 532.1 eV and the peak at 534 eV is characteristic of carbonyl Os in the presence of metals. The change in the spectrum for the N (1s) region following conjugation with the reporter probe is diagnostic for the presence of DNA. GNP/DSNB a is characterized by two peaks; a higher energy peak at 405.4 eV which is attributed to the nitro functional group and a lower energy peak at 401.1 eV corresponding to the succinimidyl N (Table 1). Following amide linkage of the reporter oligonucleotide, we detected a negligible shift in the 401.1 eV peak, which reflects the removal of succinimidyl N, and the appearance of a distinct peak at 399.6 eV, which is ascribed to heterocyclic N atoms (FIG. 16). The single peak at 134.1 eV in the P (2p) region supports this interpretation and is diagnostic for the phosphoester bonds of the DNA backbone (Table 1 and FIG. 14).

TABLE 1
XPS Binding Energies (eV) for GNP and MNP Assemblies

| Atomic | | GNP/DSNB/ |
|---|---|---|
| composition | GNP/DSNB | Reporter Probe |
| Au (4f7/2) | 83.8 | 83.8 |
| S (2p3/2) | 161.9 | 161.8 |
| S (2p1/2) | 163.1 | 163 |
| C (1s) | 284.7, 286.3, 288.3 | 284.7, 286.0, 288.5 |
| N (1s) | 405.4, 401.1 | 405.4, 401.3, 399.6 |
| O (1s) | 532.1, 534.0 | 532.4, 534.4 |
| P (2p) | nd | 134.1 |

| | | | Si-coated |
|---|---|---|---|
| | Si-coated | Si-coated MNP/ | MNP/SM(PEG)₂/ |
| | MNP | SM(PEG)₂ | Capture Probe |
| Fe (2p3/2) | 712.1 | 711.7 | nd |
| Fe (2p1/2) | 724.8 | 724.7 | nd |
| Si (2p) | 102.4-103.7 | 102.4-103.7 | 102.4-103.7 |
| O (1s) | 533.6, 531.7 | 533.5, 532.6, 531.2 | 533.6, 532.9 |
| C (1s) | 285.8, 287.0 | 285.7, 286.9, 287.5, 289.4 | 285.9, 287.0, |
| | | | 287.7, 289.1 |
| N (1s) | 400.6, 402.1 | 400.6, 402.0 | 400.9, 402.9 |
| P (2p) | nd | nd | 134.2 |
| S (2s) | nd | nd | 227.2 |

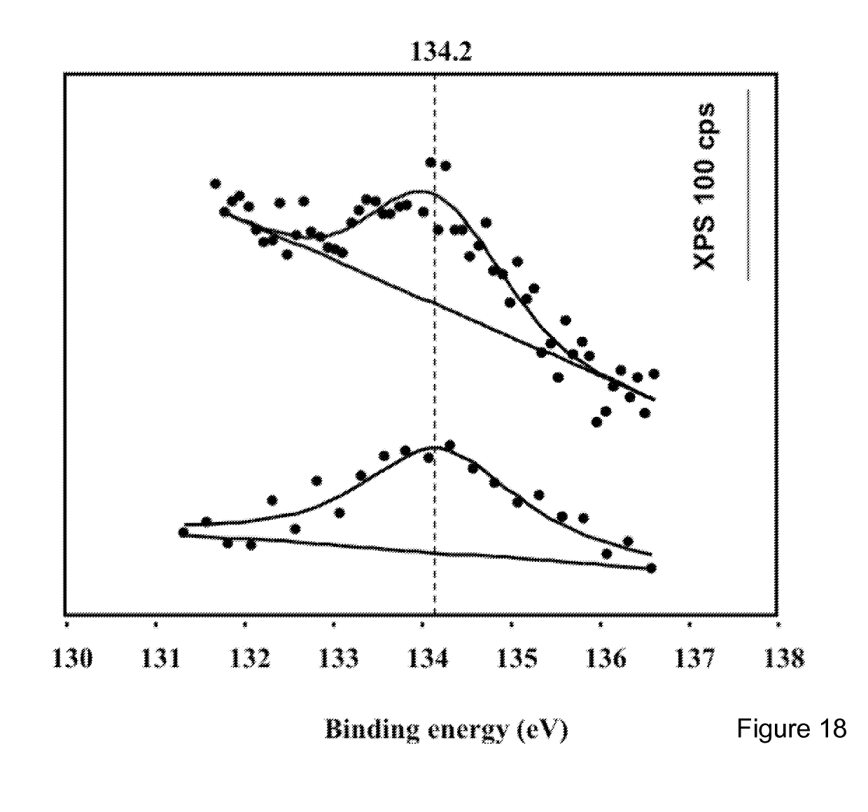

The XPS spectra for silica-coated MNPs exhibited peaks in the 102.4-103.7 eV range corresponding to the Si (2p) region, and two distinct peaks for Fe that correspond to the 2p_{3/2} and 2p_{1/2} orbitals of iron oxides were undetectable following conjugation with the capture oligonucleotide (Table 1). Although we have recorded Fe peaks for silica-coated MNPs modified with the SM(PEG)₂ linker, Kang, K.; Choi, J.; Nam, J. H.; Lee S. C.; Kim, K. J.; Lee, S.-W.; Chang, J. H., J. Phys. Chem. B 2009, 113, 536-543 have observed that binding energy peaks associated with Fe in unmodified magnetic cores particles are absent following silica coating. Additional XPS spectra which support the successful coating of magnetic core particles with silica and their subsequent conjugation with SM(PEG)₂ are indicated by the 533.5-533.6 eV peak (Si—O bond) and 532.6 eV carbonyl bond peak of O (1s), and N (1s) peaks denoting the secondary and tertiary amines (400.6 and 400.9 eV). Highlighted C bond interactions of SM(PEG)₂-coated MNPs are indicated by the low energy alkyl C peak (285.7 eV), higher energy C bonds (ie. C—N and C—Si) (286.7 eV), C—O—C ether bonds (287.5 eV) and carbonyl Cs (289.4 eV) of the C (1s) region (FIG. 16). Spectra supporting thioether linkage of the capture oligonucleotide are demonstrated by the 227.2 eV peak for the S (2s) region and the 134 eV P (2p) peak for phosphoester bonds (FIG. 14). FIG. 18 also shows an example XPS P (2p) spectra of fabricated reporter GNPs (top profile) and capture MNPs.

DLS Measurements of Fabricated Reporter GNPs and Capture MNPs.

To characterize the physical properties of NP assemblies further, DLS measurements were conducted at each step of the fabrication process. As shown in Table 2, the incremental increase in the average diameter of GNPs associated with the layering of DSNB and reporter oligonucleotide probe is consistent with the small molecular structure of DSNB and the compact structures observed for single-stranded (ss) oligonucleotides on Au surfaces. Based on the approximate base-to-base distance of 0.7 nm for ss DNA, we would predict an average hydrodynamic radius of ˜80 nm for fully extended oligonucleotides having a length of 25 bases. In contrast to GNP assembly, DLS measurements of the successive layering of SM(PEG)₂ and capture oligonucleotide probe on amine-functionalized silica-coated MNPs are less informative. Due to the high margin of error recorded for the radii of aggregated MNPs, it is difficult to unambiguously ascribe changes in the hydrodynamic radii of particle clusters with the formation of multi-layered surface assemblies.

TABLE 2
DLS Measurements of GNP and MNP Assemblies

| GNP | GNP/DSNB | GNP/DSNB/Reporter Probe |
|---|---|---|
| 31.1 ± 6.7 nm | 35.2 ± 6.5 nm | 47.2 ± 18 nm |

| | Si-coated | Si-coated MNP/ |
|---|---|---|
| Si-coated MNP | MNP/SM(PEG)₂ | SM(PEG)₂/Capture Probe |
| 202 ± 81 nm | 249.1 ± 104 nm | 251 ± 110 nm |

SERS Detection of Magnetically Captured WNV Target Sequence.

SERS spectra for WNV target sequence detection were acquired by first hybridizing reporter probe-conjugated GNPs and capture probe-conjugated MNPs with WNV target oligonucleotide and then concentrating hybridization complexes by an external magnet source for subsequent laser interrogation. Negative control hybridization reactions consisted of the absence of target sequence and the substitution of a 50 base non-specific oligonucleotide derived from the BTV genome. All hybridization reactions were conducted in 1.5 ml of high salt (i.e. 0.32 M [Na⁺]) buffer and contained ˜2.7×10¹¹ reporter GNPs/ml and ˜0.24 mg/ml of capture MNPs. Although we do not have quantitative measurements for dispersed and aggregate NP probe coverage, we assume that either the capture or reporter probe is limiting for GNP-WNV target-MNP complex formation and have ensured that probe concentrations are in sequence excess relative to the range of input target sequence concentrations tested in these experiments.

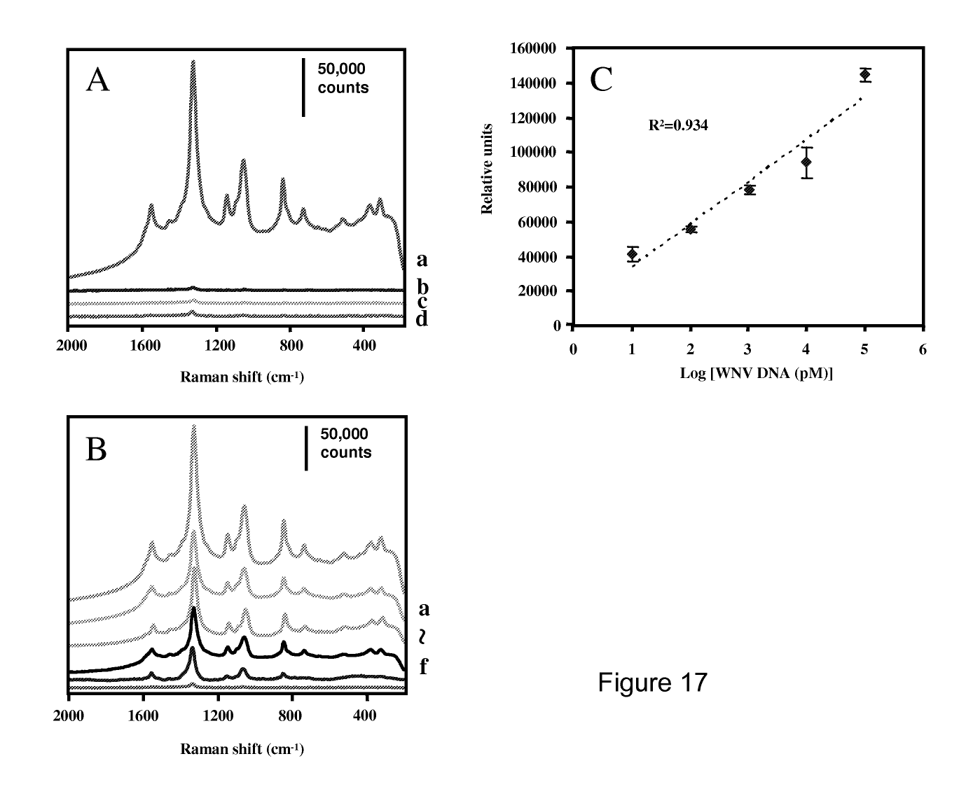

As shown in FIG. 17A, SERS detection of WNV target sequence at a concentration of 100 nM is indicated by an intense spectral peak profile specific for DSNB (spectrum a). Hybridizations containing the BTV control sequence, however, reveal only trace amounts of the dominant 1330 cm⁻¹ peak (spectrum b), the area of which is reduced by more than 200-fold relative to the same peak in spectrum a. Negative control spectra for hybridization reactions containing only reporter GNPs and capture MNPs are similar to the spectrum for BTV (spectrum c), indicating that the weak SERS signaling recorded for these controls is due to the low level, non-specific interaction of fabricated GNPs and MNPs. Of particular note, we have found that the SERS spectra for WNV target sequence hybridizations that have not been concentrated by magnetic pull-down provide spectra similar to the negative control hybridizations (spectrum d). This demonstrates the dependence of robust SERS signaling on magnetic concentration within the laser spot and further suggests that the hybridization dependent localization of DSNB on the highly irregular surfaces of dispersed MNP aggregates is insufficient for facilitating levels of detection above background. To determine the LOD sensitivity for WNV target sequence detection, SERS spectra were acquired for DNA hybridizations containing dilutions of the WNV oligonucleotide. FIG. 17B shows that there is a progressive decrease in SERS signaling as the concentration of target sequence is reduced from 100 nM to 10 pM. The spectra were background corrected and the averages of the height of the 1330 cm⁻¹ peaks were plotted versus target DNA concentration (pM) in FIG. 17C.

Additional evidence supporting the dependence of the physical interaction of reporter GNPs and capture MNPs on SERS signaling is shown in TEM images of hybridization reaction samples. Hybridizations conducted in the presence of WNV oligonucleotide (FIG. 15, upper panel) clearly illustrate the binding of high contrast GNPs with the outer surfaces of aggregated MNPs. When the target sequence is omitted from the hybridization reaction, however, we have been unable to obtain images that could be interpreted as demonstrating the physical association of GNPs with MNPs (FIG. 15, lower panel).

In this example, an NP-based, proof-of-concept SERS assay for the sensitive detection of magnetically captured DNA derived from the WNV RNA genome is demonstrated. The assay is rapid and requires approximately 1 h to perform from the time of assembling fabricated reporter GNPs and capture MNPs with the target oligonucleotide analyte to acquiring SERS spectra for the laser excitation of hybridization complexes that have been pulled out of solution and concentrated by magnetic pull-down. As spectra are easily acquired at the benchtop by simply directing the laser beam at pelleted material collected in small glass vials, the assay affords the opportunity of integration within a portable Raman spectroscopic detection format which is engineered for accommodating DNA hybridization and target sequence detection within a single vial. The features of the current assay may be optimized for enhancing detection sensitivity, thereby establishing LODs that are relevant in a diagnostic setting. Currently, magnetic capture-based SERS immunoassays have reported LODs for the tumor marker, human α-fetoprotein, and a lung cancer marker, carcinoembryonic antigen, which are considerably lower than the LODs that have been reported for DNA detection. While nucleic acid capture necessarily presents a number of technical challenges that are not encountered in the detection of antigen-antibody interactions, it is believed that SERS-based nucleic acid detection assays may be developed to provide simplified, cost-effective assay platforms that do not require target amplification and which also compete with, or even surpass, qRT-PCR technologies in analyte detection sensitivity.

One-Particle Assay

In another implementation of a magnetic capture-based SERS assay, a single particle (e.g. nanoparticle or other particle size) paramagnetic material is coated with a noble metal surface (e.g., gold or silver) to provide a SERS substrate. As described above, the single particle provides both a SERS active substrate and an ability to separate the particle from a sample. The addition of the gold layer has the added benefit of increasing the nanostructured gold content and will provide further SERS enhancement due to the increased probability of the Raman molecule being within a “hot spot”. The increased surface area of the gold coating of the particles provides a relatively high surface area of the SERS substrate of the particles by coating each particle as opposed to only a portion of the particles that are separated from the sample. In addition, a coating, as opposed to use of individual particles disposed discretely around a paramagnetic particle, also provides a relative increase in surface area coverage of the SERS substrate of the particle. Where the particle also comprises a paramagnetic nanoparticles, the single particle also provides faster diffusion within a sample analyte than other larger (e.g., micron sized) particles.

In one implementation of a particle for use in a single-particle magnetic capture-based SERS assay, for example, the particles may comprise gold-coated paramagnetic particles (e.g., nanoparticles) for single or multiplex antibody detection of antibodies to viruses and virus antigens, such as for, but not limited to, major hepatitis viruses. The gold coated paramagnetic particles, for example, may be used alone as a biosensor.

Synthesis and characterization of Au-coated Paramagnetic Particles

In one implementation, for example, iron oxide core particles may be synthesized and evaluated using two different methods. In the first, magnetite (Fe₃O₄) particles are synthesized by the high-temperature solution phase reaction of Fe (III) acetylacetonate and 1,2-hexadecanediol in the presence of oleic acid and oleylamine. Differential centrifugation of the core particles may then be performed to enrich for specific sized particles that are used as seeding material for an iterative layering of Au acetate. For the second approach, magnetite particles produced by the co-precipitation of ferrous and ferric salts are oxidized under high temperature acidic conditions to maghemite (γ-Fe₂O₃) core particles, which are then layered with Au by the iterative hydroxylamine reduction of Au³⁺ to Au. Experiments using the first method have resulted in the synthesis of 10 nm core particles with 4-5 nm thick Au shells that are paramagnetic, rapidly pulled out of solution by an externally applied magnet and exhibit physical properties consistent with an outer SERS active Au layer.

It is anticipated that enriching for magnetic core particles of different sizes and determining their rates of magnetic recovery and intrinsic SERS responsiveness upon each iterative addition of Au layering can be used to optimize the performance of the particles for one or more assays. Screening and ranking of relative SERS substrate activities for Au-coated PMPs with different core diameters and encapsulating Au layers may be performed by incubation with several different Raman scattering compounds and recording the magnitude of Raman signaling intensification upon magnetic separation. In parallel, chemically stabilizing the Au-coated PMPs may be performed in order to maximize particle dispersion in aqueous media and minimize inter-particle interactions (e.g. aggregation) that could significantly reduce surface area availability for functionalization with Raman reporters and either antibodies or antigens in later steps. Although there are several protocols that have been developed for enhancing particle solubility, citrate ion-stabilization of Au-coated PMPs is a relatively straightforward procedure that may be used to promote both particle stability and solubility.

In one implementation, gold-coated MNPs were synthesized. In this implementation, a high-temperature solution phase reaction of iron(III) acetylacetonate with 1,2-hexadecanediol in the presence of oleic acid and oleylamine leads to monodisperse magnetite (Fe₃O₄) nanoparticles. Then Fe₃O₄ nanoparticles of selected sizes (10 nm) were used as seeding materials for the reduction of gold precursors (gold acetate) to produce gold-coated Fe₃O₄ nanoparticles. The thickness of gold coating layer can be tuned from 1 to 20 nm by iterative seed-mediated growth. [J. Phys. Chem. B 2005, 109, 21593-21601.]

Room temperature aqueous phase reduction of ferrous and ferric chlorides in sodium hydroxide leads to formation of Fe₃O₄ nanoparticles. Oxidation of Fe₃O₄ nanoparticles in acid at 90-100° C. forms γ-Fe₂O₃ nanoparticles, which are used as seed crystals for the surface reduction of Au³⁺, in the form of HAuCl₄, and catalyzed by hydroxylamine. Gold-coated γ-Fe₂O₃ nanoparticles are formed and the thickness of the gold shell is controlled by number of gold and hydroxylamine additions. Gold shell thicknesses of up to 25 nm can be achieved by this method. [Nano Lett. 2004, 4, 719-723]

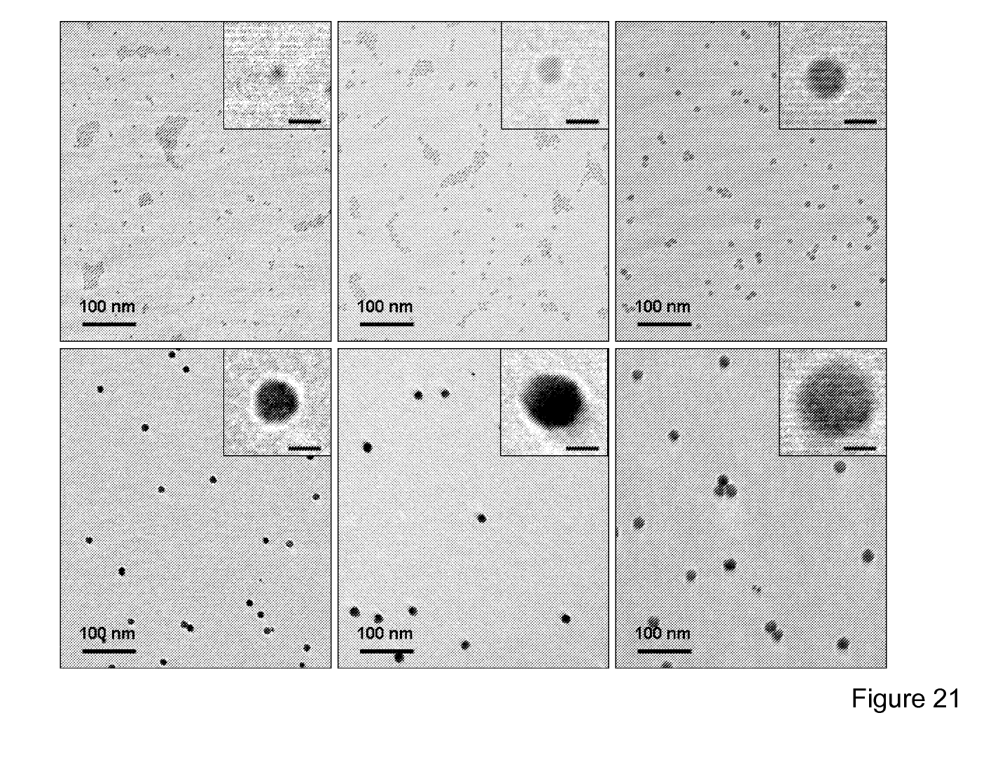

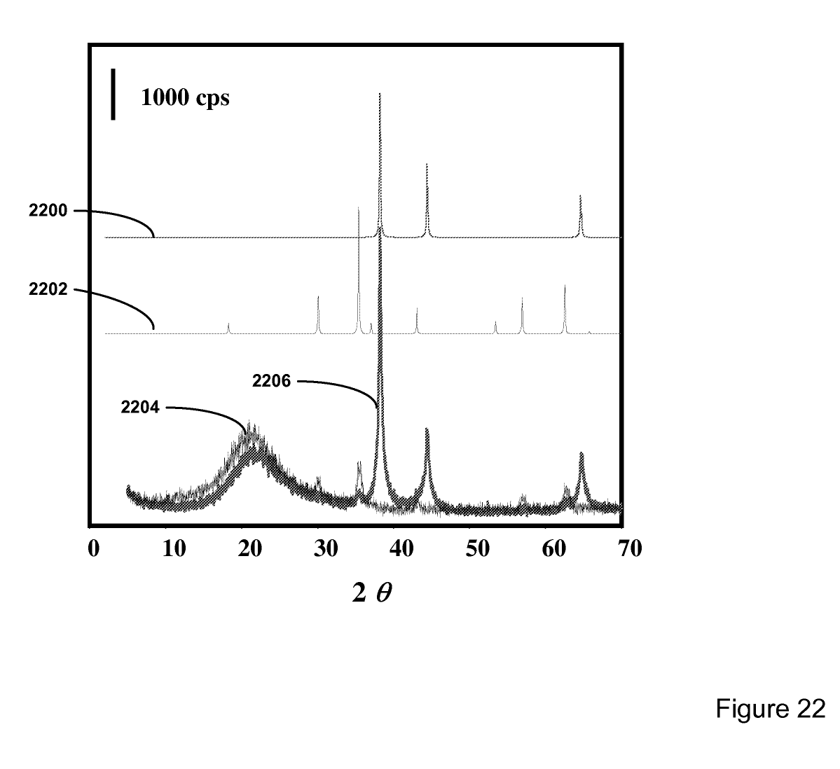

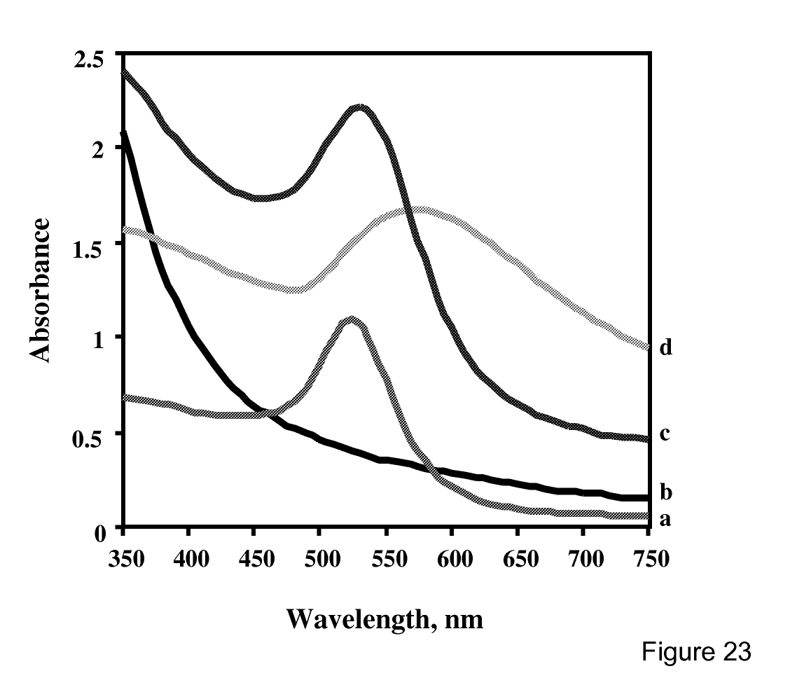

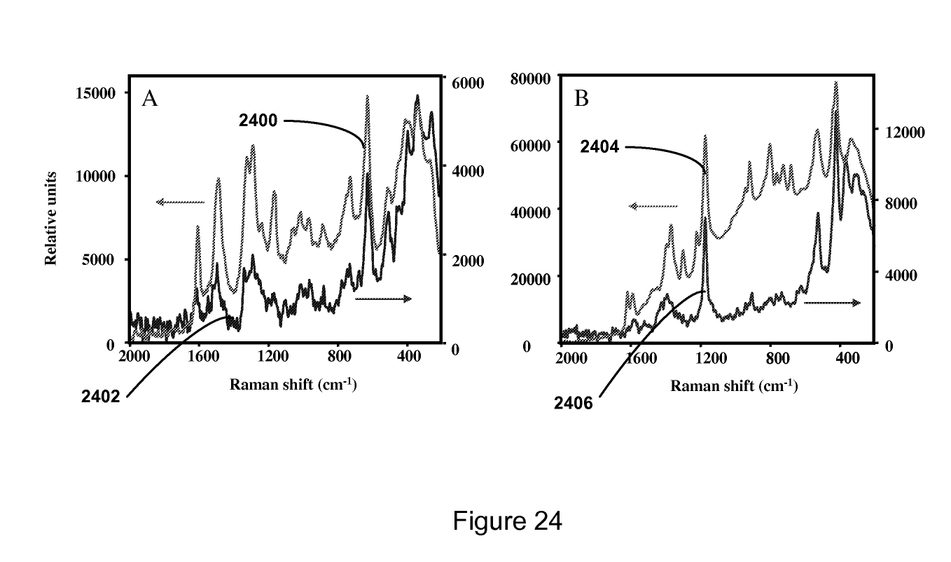

FIG. 21 shows example TEM images of Fe₃O₄ (A) 3 nm, (B) 7 nm and (C) 10 nm. Iteratively gold coated 10 nm Fe₃O₄ nanoparticles (D) 11 nm, (E) 15 nm and (F) 19 nm. FIG. 22 shows example XRD spectrum for pure Au (upper spectrum 2200), pure Fe₃O₄ (spectrum 2202), Fe₃O₄ nanoparticles (spectrum 2204) and Au coated Fe₃O₄ nanoparticles (spectrum 2206). FIG. 23 shows an example UV-Vis spectra for (a) pure Au particles, (b) Fe₂O₃ particles, (c) Au coated MNP in hexane and (d) Au coated MNP in water after rinsing. FIG. 24 shows an example SERS spectra for Erythrosin (A) on pure Au nanoparticles (2400) and on Au coated MNP (2402), and malachite green (B) on pure Au nanoparticles (2404) and on Au coated MNP (2406).

Surface Modifications of Au-Coated Paramagnetic Particles

Once the preceding objective has been met, monodisperse Au-coated paramagnetic particles (PMPs) may be functionalized with either antigen or antibody capture probes and a suitable blocking agent for the minimization of non-specific binding interactions (e.g. particle-particle interactions and non-specific protein binding). Previously reported methods of the stabilization of gold nanoparticles and the prevention of non-specific adsorption via encapsulation with silica shells and highly cross-linked BSA layers are not applicable here as our single nanoparticle assay requires a Raman label (e.g., a labeled protein) to be brought in close proximity to the gold surface through antigen/antibody binding. The silica and protein overlayers create shells prohibiting the localization of the Raman reporters within sensing distance of the gold surfaces. In a previous study using a single Au nanoparticles scheme, blocking non-specific adsorption sites with BSA was sufficient to prevent non-specific binding and aggregation during the detection of antibodies to the WNV E protein in serum while still affording high sensitivity. (See Neng, J., Harpster, M. H., Zhang, H., Mecham, J. O., Wilson, W. C., Johnson, P. J., A versatile SERS-based immunoassay for immunoglobulin detection using antigen-coated gold nanoparticles and malachite green-conjugated protein A/G. 2010, Biosens. Bioelectron., 26, 1009-1015.) One distinction in the single-particle assay system is that the use of Au-coated paramagnetic particles (e.g., nanoparticles or other size particles) would likely provide significant SERS enhancements since all of the particles within the magnetic pellet can contribute to the SERS effect.

Characterization of Fabricated Au-coated Paramagnetic Particles

Fabricated particles (e.g., nanoparticles) may be monitored at each step in their synthesis using UV-vis spectroscopy, Transmission Electron Microscopy (TEM), Dynamic Light Scattering (DLS), and X-ray Diffraction (XRD). Available DLS and TEM instrumentation can be used to provide accurate determinations of particle size distributions, assess particle aggregation and dispersion, and validate predicted increases in particle size due to their conjugation with macromolecules. Likewise, XRD and UV-vis spectroscopy can be used to validate the Au coating of the PMP. Additionaly, UV-vis spectroscopy can be used to assess particle surface coverage with protein and/or particle aggregation by recording characteristic changes in the magnitude and shape of the plasmon resonance absorbance peak of GNPs.

Fabrication of Au Nanoparticles (GNPs) for Alternative Magnetic Capture Assay

A two-particle magnetic capture assay may also be provided using the Au-coated PMPs developed above together with colloidal suspensions of modified 60 nm GNPs, such as can be obtained from Ted Pella Inc. (Redding, Calif.). To coat GNPs with antigens or antibodies, proteins can simply be absorbed due to weak ionic, hydrophilic and hydrophobic surface interactions. This approach has proven successful in the development of several SERS-based immunoassays and is performed by simply incubating GNPs with protein for extended periods in a suitable buffer and washing protein-bound GNPs in order to remove any unbound protein. As an alternative approach, proteins may be bound to GNPs that have been functionalized with various chemical groups and linkers intended for stable bioconjugate formation. Hetero-bifunctional polyethylene glycol (PEG) linkers, for instance, can contain mono- or dithiol groups at one end for strong binding to Au surfaces and amine-reactive, thiol-reactive and aldehyde and alcohol-reactive groups at the other end for attaching biomolecules. Several immunoassay studies have been reported in which a range of PEGylated linkers were used to develop NP-antibody bioconjugates with strong antigen-recognition avidities. Depending on their intended analytical application, GNPs may be conjugated first with Raman reporter molecules, followed by the sequential application of either antigens or antibodies and a blocking agent (e.g. BSA, poly (ethylene oxide), mercaptohexanol) for providing GNP stability and the prevention of non-specific binding interactions and NP aggregation. These procedures are relatively straightforward and easily monitored. Previously reported methods of the stabilization of gold nanoparticles and the prevention of non-specific adsorption via encapsulation with silica shells, highly cross-linked BSA layers, and silver overlayers are applicable here and may be considered for stable functionalization of the GNPs and Au-coated PMPs. However, again, these protective shell approaches may reduce the advantage of using Au-coated PMPs by preventing the electromagnetic enhancement manifested by the compaction of GNPs and Au-coated PMPs into a pellet upon magnetic separation.

Assays for SERS Detection

The magnetic capture particles (in a single-particle or two-particle system) can be used to provide a single-plex or multiplex assay for SERS detection.

In one implementation, for example, a multiplex assay can be an immunoassay for SERS detection of antibodies to a virus (e.g., hepatitis A, hepatitis B, and hepatitis C in serum). In this implementation, the SERS immunoassay may detect antibodies in serum that recognize each of the viral pathogens and then assemble these assays into a multiplex detection format.

Biological Reagents

Hepatitis A (HAV), B (HBV), and C(HCV) viruses have a wide commercial availability of antigen/antibody reagents. HAV is a RNA virus that is prevalent in developing countries and commonly transmitted via the fecal-oral route in contaminated water and food supplies. The acute liver inflammation that follows infection is rarely fatal and mortality is largely confined to immune-suppressed elderly individuals co-infected with either HBV or HCV. In general, HAV infection does not lead to chronic liver disease and infected individuals exhibit life-long immunity to further exposures. In contrast, HBV and HCV can confer a breadth of serious liver morbidities and are typically transmitted by exposure to the blood or blood products of infected individuals. HBV, a DNA virus, is comprised of eight genotypes found in a range of geographic locales that are often associated with distinct differences in the severity and progression of liver disease. Similarly, the HC RNA virus consists of five genotypes that elude neutralizing immune responses due to their high mutation rates.

In one implementation, Pabs and Mabs raised against the VP1 capsid protein of HAV, the surface antigen A (SAA) of HBV and the core nucleocapsid protein of HCV may be used in an assay study. Upon receipt of these antibodies and their corresponding antigens, Western blot analyses may be conducted to determine the specificity and avidity of antibody/antigen binding interactions and evidence of cross-reactivity. Information obtained from these evaluations will aid in the identification of the most appropriate reagents available for different immunoassay applications.

Raman Reporters

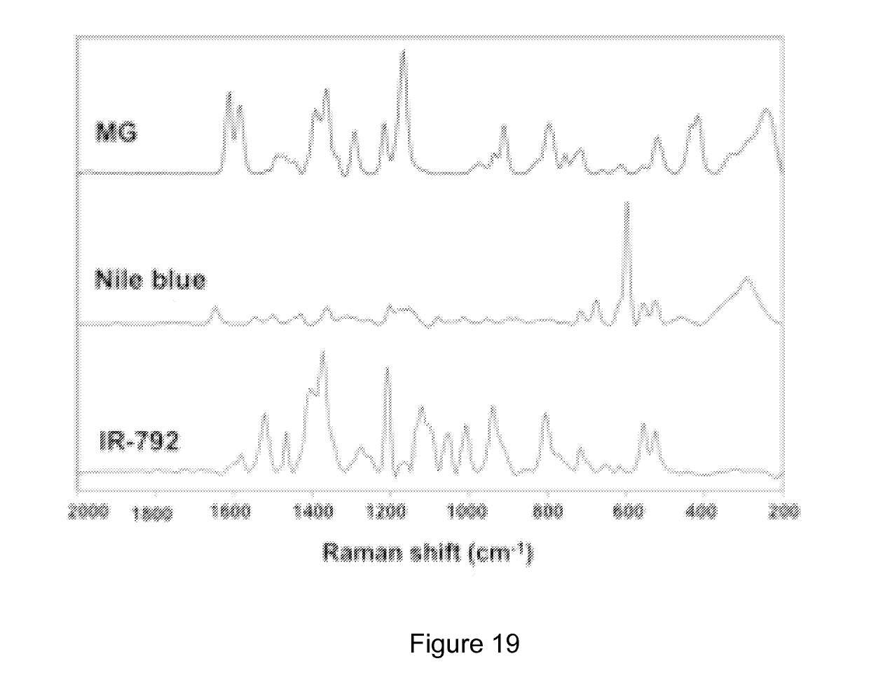

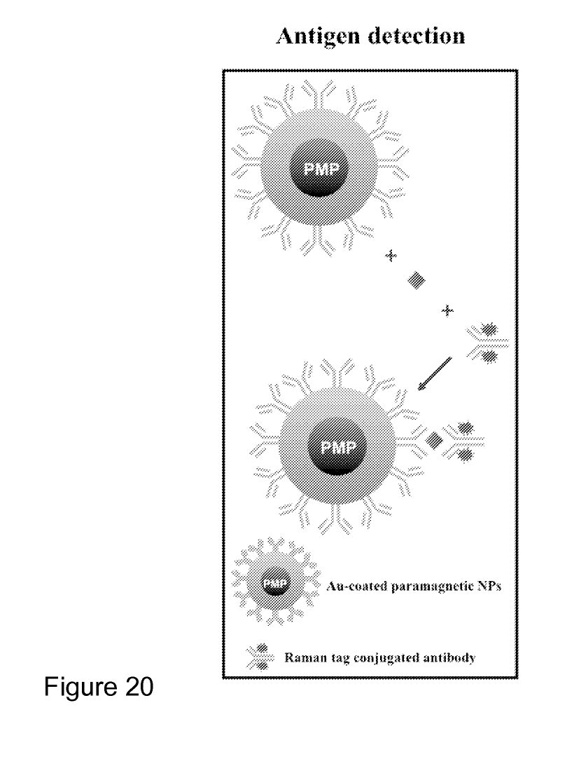

The compounds used as Raman reporters in these assays may be selected according to their inherent “brightness” and low fluorescence upon one or more laser excitation sources (e.g., at 785 nm), the clear differentiation of their Raman spectrum peak profiles for multiplexing and their availability as chemical modifications that will facilitate stable conjugation to immunoglobulin and pA/G reporter molecules or GNPs. Although it has been demonstrated that noble metal surfaces quench fluorescence, thereby minimizing background interference with SER signaling, and optimal “brightness” is achieved by tuning the wavelength of the exciting laser to the λₘₐₓ of a Raman scatterer, we have found that these properties can be thoroughly evaluated for each candidate Raman reporter that is being considered for use in assay development. The SERS spectra for three compounds that satisfy the criteria for “brightness” and minimal fluorescence include Malachite Green (MG), Nile blue (NB), and IR-792 and are shown in FIG. 19.

Using the Raman capabilities of a bench-top spectrometer, the compound IR-792 and the Raman scattering dyes MG-ITC and NB show minimal fluorescence and provide distinct spectral peaks which can be used to distinguish each reporter in a multiplex assay. With the exception of MG-ITC, however, derivatives of IR-792 and NB suitable for bioconjugation are not available. Currently, the market is focused on providing bioconjugatable derivatives of fluorescent dyes and a limited number of suitable derivatized Raman compounds are commercially available. To address this problem, a large number of non-fluorescent Raman compounds which have been reported to provide intense spectra at one or more excitation frequencies (e.g., 785 nm) may be screened and then arranged for the custom synthesis of bioconjugatable derivatives (Invitrogen Corp., Carlsbad Calif.). Raman compounds containing sulfhydryl and primary amine groups (i.e. 3-amino-1,2,4-triazole-5-thiol and pyrazinecarboxamide), for instance, can be derivatized with maleimide and isothiocyanate, respectively, and then conjugated to any protein of choice. The conjugation of Raman reporters with immunoglobulins and pA/G should not interfere with antigen recognition and Fc binding, respectively.

Detection of Antibodies Using Au-Coated Paramagnetic Particles

To develop single-particle assays for antibody detection, antigen-bound Au-coated paramagnetic particles will be incubated with target antibodies, washed to remove unbound antibodies and then incubated with Raman reporter-conjugated antibody recognition elements. Finally, developed Au-coated paramagnetic particle/antibody/Raman reporter-conjugated antibody recognition elements will be pulled out of solution by magnetic concentration and queried by laser interrogation. Spectral data acquisitions will be performed on the bench-top using a spectrometer (e.g., an Advantage NIR spectrometer fitted with right angle field optics) directing a laser beam at samples that have been concentrated to the side of glass vials using an external magnet source. Although this is likely a sub-optimal method for laser interrogation, we have nevertheless been quite successful in demonstrating low LODs for several different analytes.

Example Multiplex Immunoassays for SERS Detection of HAV, HBV, and HCV Antigens

An example multiplex immunoassay for SERS detection of HAV, HBV, and HCV antigens is provided. This immunoassay is merely an example of an immunoassay for antigens.

Multiplex assays are also contemplated for other types of antigens. The immunoassays for the detection of HAV, HBV and HCV antigens in a multiplex assay format complement the multiplex assay for antibody detection described above. For the illustrated hepatic viruses, the tests may provide detection of viremic infections in drawn blood and stored blood products, or, as in the case of HAV, the detection of virus in contaminated water supplies.

Multiplex Detection of Antigens Using Au-Coated Paramagnetic Particles

Antigen capture and SERS detection using Au-coated PMPs is illustrated in FIG. 20. Au-coated paramagnetic particles (PMPs) fabricated with antigen-specific antibody, antigen and Raman reporter-conjugated antibody may be incubated and then pulled out of solution by a magnet source for laser excitation and spectrum acquisition. For multiplex analysis, assays may be developed using mixed preparations of Au-coated PMPs conjugated separately with Pc HAV, HBV and HCV antibodies, and the same antibodies, or Mabs, individually conjugated to a unique Raman reporter. To enhance detection sensitivity, the Mabs and/or Pabs used for this application may be enriched for the IgG fraction by affinity chromatography (e.g. protein A-Sepharose). One example of a Raman reporter that can be easily conjugated to proteins is MG-ITC. Detection sensitivity may be determined by serially diluting the concentration of each antigen in the reaction and the effect of varying amounts of each antigen in assembled multiplex assays may be tested to determine whether, and to what extent, the spectrum for a more highly concentrated antigen obscures the positive identification of a less concentrated antigen.

Multiplex Detection of Antigens Using Gold Nanoparticles and Au-Coated Paramagnetic Particles

An example scheme for a two-particle-based magnetic capture and SERS detection of antigen is also provided that is simple in design and provides low LOD sensitivities. GNPs coated with a Raman reporter and antibodies specific for the target antigen will be incubated with antigen and Au-coated PMPs modified with either the same or different antigen-specific antibodies. As long as there is no significant competition of the GNP and Au-coated PMP antibodies with the same epitope(s), antigen capture will couple GNPs and Au-coated PMPs, which will then be extracted out of solution by magnetic pull-down and concentrated for laser excitation. For multiplex antigen detection, reporter GNPs and Au-coated PMPs may be fabricated for the targeted detection of each antigen and then assay reagent formulations may be developed that contain mixtures of six different NPs.

Prior to developing multiplex assays, monoplex assays for the detection of each antigen may be optimized. Activities include determining the minimum incubation time required for attaining maximum detection sensitivity and also determining whether the assay can be conducted using a “no wash” format. In contrast to antibody detection assays in which it is necessary to precipitate antibody-bound GNPs and Au-coated PMPs in order to remove unbound antibodies from the reaction, it should be possible to incubate antigens and NP reagents for a specified period and then immediately extract captured antigen for spectrum data acquisition.

Although many embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A detection assay for detecting a target nucleic acid via surface enhanced Raman spectroscopy, the assay comprising:
a plurality of first particle biosensors comprising paramagnetic material coupled to a first nucleic acid probe; and
a plurality of second particle biosensors comprising a noble metal material coupled to a second nucleic acid probe and a Raman label, the first and second nucleic acid probes being complementary nucleic acid probes specific to the target nucleic acid.

2. The detection assay of claim 1 wherein the plurality of first particle biosensors comprise paramagnetic nanoparticles.

3. The detection assay of claim 2 wherein the plurality of first particle biosensors further comprise silica-shell paramagnetic nanoparticles.

4. The detection assay of claim 2 wherein the plurality of second particle biosensors comprise noble metal nanoparticles.

5. The detection assay of claim 1 wherein the plurality of second particle biosensors comprise noble metal nanoparticles.

6. The detection assay of claim 1 wherein the first nucleic acid probe comprises a modified single stranded DNA oligonucleotide or DNA analog.

7. The detection assay of claim 6 wherein the second nucleic acid probe comprises a modified single stranded DNA oligonucleotide or DNA analog.

8. The detection assay of claim 1 wherein the second nucleic acid probe comprises a modified single stranded DNA oligonucleotide or DNA analog.

9. The detection assay of claim 1 further comprising:
a plurality of third particle biosensors comprising paramagnetic material coupled to a third nucleic acid probe; and
a plurality of fourth particle biosensors comprising a noble metal material coupled to a fourth nucleic acid probe, the third and fourth nucleic acid probes being complementary nucleic acid probes specific to a second target nucleic acid,
wherein the first, second, third and fourth particle biosensors provide a multiplex assay for detecting the target nucleic acid via the first and second particle biosensors and detecting the second target nucleic acid via the third and fourth particle biosensors.

10. The detection assay of claim 9 further comprising:
a plurality of fifth particle biosensors comprising paramagnetic material coupled to a fifth nucleic acid probe; and
a plurality of sixth particle biosensors comprising noble metal material coupled to a sixth nucleic acid probe and a third Raman label, the fifth and sixth nucleic acid probes being complementary nucleic acid probes specific to a third target nucleic acid,
wherein the first, second, third, fourth, fifth, and sixth particle biosensors provide a multiplex assay for detecting the target nucleic acid via the first and second particle biosensors, detecting the second target nucleic acid via the third and fourth particle biosensors, and detecting the third target nucleic acid via the fifth and sixth particle biosensors.

11. The detection assay of claim 1 wherein the noble metal material comprises at least one of Au, Ag, and Cu.

12. A method of detecting a target nucleic acid via a magnetic capture-based surface enhanced Raman spectroscopy assay, the method comprising:
providing a plurality of first particle biosensors comprising paramagnetic material coupled to a first nucleic acid probe and a plurality of second particle biosensors comprising a noble metal material coupled to a second nucleic acid probe and a Raman label, the first and second nucleic acid probes being complementary nucleic acid probes specific to the target nucleic acid;
mixing an analyte comprising the target nucleic acid with the plurality of first particle biosensors and second particle biosensors, wherein the first and second nucleic acid probes bind to the target nucleic acid;
exposing the mixture of the analyte and particle biosensors to an electromagnetic field to attract the first particle biosensors to a target location;
exciting the target location with an excitation light source; and
detecting a Raman signal corresponding to the Raman label indicating the presence of the target nucleic acid.

13. The method of claim 12 wherein the plurality of first particle biosensors comprise paramagnetic nanoparticles.

14. The method of claim 13 wherein the plurality of first particle biosensors further comprise silica-shell paramagnetic nanoparticles.

15. The method of claim 13 wherein the plurality of second particle biosensors comprise noble metal nanoparticles.

16. The method of claim 12 wherein the plurality of second particle biosensors comprise noble metal nanoparticles.

17. The method of claim 12 wherein the first nucleic acid probe comprises a modified single stranded DNA oligonucleotide or DNA analog.

18. The method of claim 17 wherein the second nucleic acid probe comprises a modified single stranded DNA oligonucleotide or DNA analog.

19. The method of claim 12 wherein the second nucleic acid probe comprises a modified single stranded DNA oligonucleotide or DNA analog.

20. The method of claim 12 further comprising:
providing a plurality of third particle biosensors comprising paramagnetic material coupled to a third nucleic acid probe; and a plurality of fourth particle biosensors comprising a noble metal material coupled to a fourth nucleic acid probe and a second Raman label, the third and fourth nucleic acid probes being complementary nucleic acid probes specific to a second target nucleic acid,
wherein the first, second, third and fourth particle biosensors provide a multiplex assay for detecting the target nucleic acid via the Raman label coupled to the second particle biosensors and detecting the second target nucleic acid via the second Raman label coupled to the fourth particle biosensors.

21. The method of claim 20 further comprising:
providing a plurality of fifth particle biosensors comprising paramagnetic material coupled to a fifth nucleic acid probe and a plurality of sixth particle biosensors comprising a noble metal material coupled to a sixth nucleic acid probe and a third Raman label, the fifth and sixth nucleic acid probes being complementary nucleic acid probes specific to a third target nucleic acid,
wherein the first, second, third, fourth, fifth, and sixth particle biosensors provide a multiplex assay for detecting the target nucleic acid via the Raman label coupled to the second particle biosensor, detecting the second target nucleic acid via the second Raman label coupled to the fourth particle biosensor and detecting the third target nucleic acid via the third Raman label coupled to the sixth particle biosensor.

22. The method of claim 12 wherein the operation of mixing comprises diffusion.

23. The method of claim 12 wherein the noble metal material comprises at least one of Au, Ag, and Cu.

24. A method of detecting a target nucleic acid via a magnetic capture-based surface enhanced Raman spectroscopy assay, the method comprising:
providing a plurality of first particle biosensors comprising paramagnetic material coupled to a first nucleic acid probe and a plurality of second particle biosensors comprising a noble metal material coupled to a second nucleic acid probe and a Raman label, the first and second nucleic acid probes being complementary nucleic acid probes specific to the target nucleic acid;
mixing an analyte with the plurality of first particle biosensors and second particle biosensors, wherein the first and second nucleic acid probes bind to the target nucleic acid if the target nucleic acid is present in the analyte;
exposing the mixture of the analyte and particle biosensors to an electromagnetic field to attract the first particle biosensors to a target location;
exciting the target location with an excitation light source; and
determining whether a Raman signal corresponding to the Raman label indicating the presence of the target nucleic acid is received.

25. The method of claim 24 wherein the plurality of first particle biosensors comprise paramagnetic nanoparticles.

26. The method of claim 25 wherein the plurality of first particle biosensors further comprise silica-shell paramagnetic nanoparticles.

27. The method of claim 25 wherein the plurality of second particle biosensors comprise Au nanoparticles.

28. The method of claim 24 wherein the plurality of second particle biosensors comprise Au nanoparticles.

29. The method of claim 24 wherein the first nucleic acid probe comprises a modified single stranded DNA oligonucleotide or DNA analog.

30. The method of claim 29 wherein the second nucleic acid probe comprises a modified single stranded DNA oligonucleotide or DNA analog.

31. The method of claim 24 wherein the second nucleic acid probe comprises a modified single stranded DNA oligonucleotide or DNA analog.

32. The method of claim 24 further comprising:
providing a plurality of third particle biosensors comprising paramagnetic material coupled to a third nucleic acid probe; and a plurality of fourth particle biosensors comprising a noble metal material coupled to a fourth nucleic acid probe and a second Raman label, the third and fourth nucleic acid probes being complementary nucleic acid probes specific to a second target nucleic acid,
wherein the first, second, third and fourth particle biosensors provide a multiplex assay for detecting the target nucleic acid via the Raman label coupled to the second particle biosensors and detecting the second target nucleic acid via the second Raman label coupled to the fourth particle biosensors.

33. The method of claim 32 further comprising:
providing a plurality of fifth particle biosensors comprising paramagnetic material coupled to a fifth nucleic acid probe and a plurality of sixth particle biosensors comprising a noble metal material coupled to a sixth nucleic acid probe and a third Raman label, the fifth and sixth nucleic acid probes being complementary nucleic acid probes specific to a third target nucleic acid,
wherein the first, second, third, fourth, fifth, and sixth particle biosensors provide a multiplex assay for detecting the target nucleic acid via the Raman label coupled to the second particle biosensor, detecting the second target nucleic acid via the second Raman label coupled to the fourth particle biosensor and detecting the third target nucleic acid via the third Raman label coupled to the sixth particle biosensor.

34. The method of claim 24 wherein the operation of mixing comprises diffusion.

35. The method of claim 24 wherein the noble metal material comprises at least one of Au, Ag, and Cu.

36. A detection assay for detecting a target nucleic acid via surface enhanced Raman spectroscopy magnetic capture-based assay, the assay comprising:
a plurality of particles comprising an inner paramagnetic particle at least substantially coated by a noble metal coating, the particle further comprising a target-specific probe for selectively coupling to the target analyte; and
a plurality of Raman label conjugated target analyte recognition elements.

37. The detection assay of claim 36 wherein the inner paramagnetic particle comprises a nanoparticle paramagnetic particle.

38. The detection assay of claim 36 wherein the noble metal coating comprises an Au coating.

39. The detection assay of claim 36 wherein the noble metal coating comprises at least one of Au, Ag, and Cu.

40. The detection assay of claim 36 further comprising:
a plurality of second particles comprising an inner paramagnetic particle at least substantially coated by a noble metal coating, the particle further comprising a second target-specific probe for selectively coupling to a second target analyte; and
a plurality of second Raman label conjugated target analyte recognition elements for selectively coupling to the second target analyte.

41. The detection assay of claim 36 wherein the Raman label conjugated target analyte recognition elements comprise at least one of DNA, an antigen, a protein, and a protein pA/G.

42. A method of detecting a target analyte via a magnetic capture-based surface enhanced Raman spectroscopy assay, the method comprising:
providing a plurality of particles comprising an inner paramagnetic particle at least substantially coated by a noble metal coating, the particle further comprising a target-specific probe for selectively coupling to the target analyte; and a plurality of Raman label conjugated target analyte recognition elements;
mixing an analyte comprising the target analyte with the plurality of particles and Raman label conjugated target analyte recognition elements, wherein the target-specific probe and Raman label conjugated target analyte recognition elements bind to the target analyte;
exposing the mixture of the analyte, particles and Raman label conjugated target analyte recognition elements to an electromagnetic field to attract the plurality of particles to a target location;
exciting the target location with an excitation light source; and
detecting a Raman signal corresponding to the Raman label indicating the presence of the target analyte.

43. The method of claim 42 wherein the inner paramagnetic particles of the plurality of particles comprise paramagnetic nanoparticles.

44. The method of claim 42 further comprising providing a plurality of noble metal nanoparticles each comprising a second target-specific probe for selectively coupling to the target analyte.

45. The method of claim 42 wherein the target-specific probe comprises a nucleic acid probe.

46. The method of claim 45 wherein the nucleic acid probe comprises a modified single stranded DNA oligonucleotide or DNA analog.

47. The method of claim 42 further comprising:
providing a second plurality of particles comprising a second inner paramagnetic particle at least substantially coated by a second noble metal coating, the particle further comprising a second target-specific probe for selectively coupling to the target analyte; and a plurality of second Raman label conjugated target analyte recognition elements for selectively coupling to a second target analyte;
wherein the plurality of particles, the Raman label conjugated target analyte recognition elements, the second plurality of particles, and the second Raman label conjugated target analyte recognition elements provide a multiplex assay for detecting the target analyte via plurality of particles and Raman label conjugated target analyte recognition elements and detecting the second target analyte via the second plurality of particles and the second Raman label conjugated target analyte recognition elements.

48. The method of claim 42 wherein the operation of mixing comprises diffusion.

49. The method of claim 42 wherein the noble metal material comprises at least one of Au, Ag, and Cu.

50. An assay for detecting a target analyte via surface enhanced Raman spectroscopy, the assay comprising:
a plurality of first nanoparticle biosensors comprising paramagnetic material coupled to a first probe; and
a plurality of second nanoparticle biosensors comprising a noble metal material coupled to a second probe and a Raman label, the first and second probes being adapted to selectively couple to the target analyte.

51. The assay of claim 50 wherein the plurality of first nanoparticle biosensors each comprise a paramagnetic nanoparticle at least substantially coated by a noble metal material.

52. The detection assay of claim 50 wherein the plurality of first nanoparticles biosensors comprise nanoparticle paramagnetic particles.

53. The detection assay of claim 50 wherein the noble metal material comprises an Au coating.

54. The detection assay of claim 50 wherein the noble metal material comprises at least one of Au, Ag, and Cu.

55. The detection assay of claim 50 further comprising:
a plurality of third nanoparticle biosensors comprising paramagnetic material coupled to a third probe; and
a plurality of fourth nanoparticle biosensors comprising a noble metal material coupled to a fourth probe and a Raman label, the third and fourth probes being adapted to selectively couple to a second target analyte.
